(19) United States
(12) Patent Application Publication
(10) Pub. No.: US 2023/0091610 A1
(43) Pub. Date: Mar. 23, 2023

(54) SYSTEMS AND METHODS OF GENERATING AND VALIDATING TIME-SERIES FEATURES USING MACHINE LEARNING

(71) Applicant: DataRobot, Inc., Boston, MA (US)

(72) Inventors: Anastasiia Tamazlykar, Kyiv (UA); Igor Iaroshenkno, Kyiv (UA); Mark Steadman, Watertown, MA (US); Jilian Schwiep, Miami, FL (US); Peter Michael Simon, Overath, NRW (DE); Zachary Deane-Mayer, Cohasset, MA (US); Brett Rowley, Medford, MA (US); Jing Qiang Goh, Singapore (SG)

(73) Assignee: DataRobot, Inc., Boston, MA (US)

(21) Appl. No.: 17/942,458

(22) Filed: Sep. 12, 2022

Related U.S. Application Data
(60) Provisional application No. 63/243,507, filed on Sep. 13, 2021.

(51) Int. Cl. G06N 5/02

(52) U.S. Cl. CPC G06N 5/022

(57) ABSTRACT

This disclosure relates generally to using machine learning models to generate current time-series features using machine learning and validate time-series machine learning model output. At least one aspect is directed to a system with one or more processors, coupled to memory, to segment a time series range into a first segment for an instance of time, the segment associated with a value for a target feature and a timestamp for the value, segment the time series range into an input segment associated with a plurality of input features and a segment timestamp less than or equal to the timestamp, generate a model trained with input comprising values for the target feature and timestamps for the values less than or equal to the segment timestamp, and transform at least one of the input features based at least on the model.

### CROSS-REFERENCES TO RELATED APPLICATIONS

This application claims the benefit of priority under 35 U.S.C. § 119 to U.S. Provisional Patent Application No. 63/243,507, filed Sep. 13, 2021, which is hereby incorporated by reference herein in its entirety for all purposes.

### FIELD OF THE DISCLOSURE

This disclosure relates generally to using machine learning models to generate current time-series features using machine learning and validate time-series machine learning model output.

### INTRODUCTION

Many organizations and individuals use electronic data to improve their operations or aid their decision-making. For example, many business enterprises use data management technologies to enhance the efficiency of various business processes, such as executing transactions, tracking inputs and outputs, or marketing products. As another example, many businesses use operational data to evaluate performance of business processes, to measure the effectiveness of efforts to improve processes, or to decide how to adjust processes.

In some cases, electronic data can be used to anticipate problems or opportunities. Some organizations combine operations data describing what happened in the past with evaluation data describing subsequent values of performance metrics to build predictive models. Based on the outcomes predicted by the predictive models, organizations can make decisions, adjust processes, or take other actions. For example, an insurance company might seek to build a predictive model that more accurately forecasts future claims, or a predictive model that predicts when policyholders are considering switching to competing insurers. An automobile manufacturer might seek to build a predictive model that more accurately forecasts demand for new car models. A fire department might seek to build a predictive model that forecasts days with high fire danger, or predicts which structures are endangered by a fire.

### SUMMARY

This technical solution is directed to systems and methods to generate current time-series model output and validate time-series model output using machine learning. For example, systems and methods of this technical solution can automatically identify one or more features associated with a particular instantaneous value, thus providing real-time generation and modification of features influencing an instantaneous value. For example, systems and methods of this technical solution can automatically can validate a time-series model with granularity including validation within multiple discrete time segments within the time series range of the model or a dataset input to the mode.

A system of this technical solution can generate one or more outputs of a machine learning system based on one or more inputs to the machine learning system. The outputs can include one or more input features modified to indicate a correspondence with a particular instantaneous value of a feature. The modification of the features can occur in real-time, or at a rate corresponding to a rate of transmission or receipt of information from external databases and over distributed or Internet networks. An instantaneous value can include a current value of a target feature. Thus, a system of this technical solution can rapidly identify factors contributing to the current value or the current change in value of a particular feature. The target feature itself can also be an input to the system. As one example, a system can generate an output indicating current GDP value for a particular country, and can identify inputs that contribute most to the current GDP, including, for example, third party information such as shipping rates, stock market metrics, and even previous GDP values at earlier points in time. Thus, the technical solution can answer in real-time and by an automated process, “What factors are contributing now to the GDP now?” Outputs of this technical solution can be referred to as “nowcasting.”

A system of this technical solution can validate a machine learning model with respect to one or more time-series segments of the machine learning model. Time-series segments of the machine learning model can include particular time ranges associated with the model or a dataset input to the model. As one example, a dataset input to the model can include data representing sales of swimwear for the Boston metropolitan market over one year. The technical solution can validate whether a model is predictive of the sales, at a granularity higher than the entire time range associated with the model. The technical solution can thus generate segments of the time range in which the model does or does not accurately predict sales, for example, within a particular threshold. As one example, the technical solution can segment a yearlong-time series into a segment that identifies the month of November, where sales exceed the prediction by a threshold. In this example, the spike in sales could be attributed to sales of swimsuits by consumers traveling from Boston to another, warmer, location during the holiday season. The technical solution can include a user interface to present a time-series range that includes a time series segment highlighting the November time segment as not predictive of swimsuit sales. Multiple ranges can also be identified. For example, a model may be predictive of swimsuit sales in all but the second and fourth weeks of November. The user interface can then present two discontinuous time segments, each associated with the second and fourth weeks of November, respectively, and surrounding a time segment including the third week of November that indicates the model is predictive with respect to the threshold. Thus, the technical solution can automatically validate a machine learning model with a high level of granularity with respect to a time-series range.

Machine-learning techniques (e.g., supervised statistical-learning techniques) may be used to generate a predictive model from a dataset that includes previously recorded observations of at least two variables. The variable(s) to be predicted may be referred to as “target(s)”, “response(s)”, or “dependent variable(s)”. The remaining variable(s), which can be used to make the predictions, may be referred to as “feature(s)”, “predictor(s)”, or “independent variable(s)”. The observations are generally partitioned into at least one “training” dataset and at least one “test” dataset. A data analyst then selects a statistical-learning procedure and executes that procedure on the training dataset to generate a predictive model. The analyst then tests the generated model on the test dataset to determine how well the model predicts the value(s) of the target(s), relative to actual observations of the target(s).

At least one aspect is directed to a system with one or more processors, coupled to memory, to segment a time series range into a first segment for an instance of time, the segment associated with a value for a target feature and a timestamp for the value, segment the time series range into an input segment associated with a plurality of input features and a segment timestamp less than or equal to the timestamp, generate a model trained with input comprising values for the target feature and timestamps for the values less than or equal to the segment timestamp, and transform at least one of the input features based at least on the model.

At least one aspect is directed to a method of segmenting, by a data processing system, a time series range into a first segment for an instance of time, the first segment associated with a first value for a target feature and a first timestamp for the first value, segmenting, by the data processing system, the time series range into an input segment associated with a plurality of input features and a segment timestamp less than or equal to the first timestamp, and generating, by the data processing system, a model trained with input comprising values for the target feature and timestamps less than or equal to the segment timestamp, and transforming, by the data processing system, at least one of the input features based at least on the model.

At least one aspect is directed to a computer readable medium including one or more instructions stored thereon and executable by a processor to segment a time series range into a first segment for an instance of time, the first segment associated with a first value for a target feature and a first timestamp for the first value, segment the time series range into an input segment associated with a plurality of input features and a segment timestamp less than or equal to the first timestamp, generate a model trained with input comprising values for the target feature, and timestamps less than or equal to the segment timestamp, and transform at least one of the input features based at least on the model.

At least one aspect is directed to a system one or more processors, coupled to memory, to receive, via a network from a device of a customer, a model generated with a time-series range, generate, using the model, a first value with a first timestamp within the time-series range, generate a second value with the same first timestamp from a reference model that is different from the model, generate a first metric based on the first value and the second value, and identify, responsive to the first metric satisfying a threshold, at least one segment comprising a subset of the time-series range that includes the same first timestamp, and provide, via the network, an indication of the at least one segment to the device of the customer.

At least one aspect is directed to a method of receiving, via a network, a model generated from a customer device remote from the data processing system, the model having a time-series range, generating, by a data processing system and using the model, a first value with a first timestamp within the time-series range, generating, by the data processing system, a second value with the same first timestamp from a reference model that is different from the model, generate, by the data processing system, a first metric based on the first value and the second value, identifying, by the data processing system and responsive to the first metric satisfying a threshold, at least one segment comprising a subset of the time-series range that includes the same first timestamp, and providing, via the network, an indication of the at least one segment to the device of the customer.

At least one aspect is directed to a computer readable medium including one or more instructions stored thereon and executable by a processor to receive, via a network, a model generated from a customer device remote from the data processing system, the model having a time-series range, generate, by a sample generator and using the model, a first value with a first timestamp within the time-series range, extract, by the sample generator, a second value with the same first timestamp from a reference model that is different from the model, generate, by a spatial processor, a first metric based on the first value and the second value, segment, by a segmentation engine and responsive to the first metric satisfying a threshold, the time-series range into at least one segment comprising a subset of the time-series range that includes the same first timestamp, and provide, via the network, an indication of the segment to the device of the customer.

Other aspects and advantages of this solution will become apparent from the following drawings, detailed description, and claims, all of which illustrate the principles of the solution, by way of example only.

### BRIEF DESCRIPTION OF THE DRAWINGS

Advantages of the some implementations may be understood by referring to the following description taken in conjunction with the accompanying drawings. In the drawings, like reference characters generally refer to the same parts throughout the different views. Also, the drawings are not necessarily to scale, emphasis instead generally being placed upon illustrating principles of some implementations of the solution.

FIG. 1A illustrates a method for generating time series features using machine learning, in accordance with present implementations.

FIGS. 1B-1C illustrate a method for validating time series machine learning model output, in accordance with present implementations.

FIG. 2A is a user interface to generate a selection of a machine learning model, in accordance with present implementations.

FIG. 2B is a first user interface to generate a time series model, in accordance with present implementations.

FIG. 3 illustrates a first example time-series range structure further to the example user interface of FIG. 2.

FIG. 4 is a first user interface to generate a time series model further to the example user interface of FIG. 2.

FIG. 5 is a first user interface to obtain a model, in accordance with present implementations.

FIG. 6 is a second user interface to obtain a model further to the example user interface of FIG. 5.

FIG. 7 is a first user interface to present output according to a time-series model, in accordance with present implementations.

FIG. 8 is a second user interface to present output according to a time-series model further to the example user interface of FIG. 7.

FIG. 9A is a block diagram of implementations of a computing device;

FIG. 9B is a block diagram depicting a computing environment that includes a client device in communication with a cloud service provider;

FIG. 10 is a block diagram of a predictive modeling system, in accordance with some implementations;

FIG. 11 is a block diagram of a modeling tool for building machine-executable templates encoding predictive modeling tasks, techniques, and methodologies, in accordance with some implementations;

FIG. 12 is a flowchart of a method for selecting a predictive model for a prediction problem, in accordance with some implementations;

FIG. 13 shows another flowchart of a method for selecting a predictive model for a prediction problem, in accordance with some implementations;

FIG. 14 is a schematic of a predictive modeling system, in accordance with some implementations;

FIG. 15 is another block diagram of a predictive modeling system, in accordance with some implementations.

### DETAILED DESCRIPTION

This disclosure is generally related to generating and validating time-series features using machine learning.

This disclosure is described with reference to the drawings, which are provided as illustrative examples of the implementations so as to enable those skilled in the art to practice the implementations and alternatives apparent to those skilled in the art. Notably, the figures and examples below are not meant to limit the scope of the implementations to a single implementation, but other implementations are possible by way of interchange of some or all of the described or illustrated elements. Moreover, where certain elements of the implementations can be partially or fully implemented using known components, only those portions of such known components that are necessary for an understanding of the implementations will be described, and detailed descriptions of other portions of such known components will be omitted so as not to obscure the implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the implementations encompass present and future known equivalents to the known components referred to herein by way of illustration.

For purposes of reading the description of the various implementations below, the following descriptions of the sections of the specification and their respective contents may be helpful:

Section A describes systems and methods of generating and validating time-series features using machine learning.

Section B describes a computing environment which may be useful for practicing implementations described herein; and

Section C describes a predictive modeling system which may be useful for practicing implementations described herein.

### A. Generating Current Time-Series Features Using Machine Learning

Implementations are directed to generating at least one output of a machine learning model generate explanatory factors that contribute to instantaneous values or parameters, for example, associated with a target feature. Explanatory factors can include, but are not limited to, metrics associated with a degree of correlation between one or more inputs features and the target feature. These systems and methods can be associated with nowcasting. Users can upload a time series data set and can select relevant special values (e.g., target feature or value of interest, datetime value or range) from a graphical user interface (“GUI”) to generate a real-time machine learning model output responsive business questions with minimal time series configuration. Configuration can include a user selection of or an automatically generated feature derivation window. Implementations are directed to a time series framework and can include forecast distances. Similarly, nowcasting can provide a GUI or the like to automatically set up a time series modelling framework to answer nowcasting problems. Technical solutions to nowcasting problems can include generating explanatory factors that contribute to instantaneous values or parameters, for example, associated with a target feature.

Implementations are directed to automated time series feature derivation compatible with nowcasting input criteria. Input criteria can include, but are not limited to values of target features associated with the time series. Non-target features (e.g., covariates) can be predetermined inputs to a machine learning models. The non-target features can be identified before input to allow real-time features to generate an output predictive of the target feature. As one example, real-time features can include ‘latest transaction volume of stock’ and a target feature can include ‘latest known price index.’ The GUI can receive a user selection of a desired feature derivation window setting and mark covariates as known in advance. The GUI can provide guardrails to prevent the automatically derived features from resulting in target leakage. Guardrails can include restrictions on potential user selections, including restrictions or boundaries on a selectable feature derivation window. A restriction can include restricting a feature derivation window from extending within a predetermined time range of a present time point, to ensure that the most recent rolling or real-time statistics do not result in target leakage, and to reduce or eliminate model behavior including output predicting unrealistic, inaccurate performance. Accuracy Over Time, Series Accuracy, and Feature Impact are available. For example, feature impact can indicate input features that correlate to or are predictive of a current, rolling, or real-time value of a target feature.

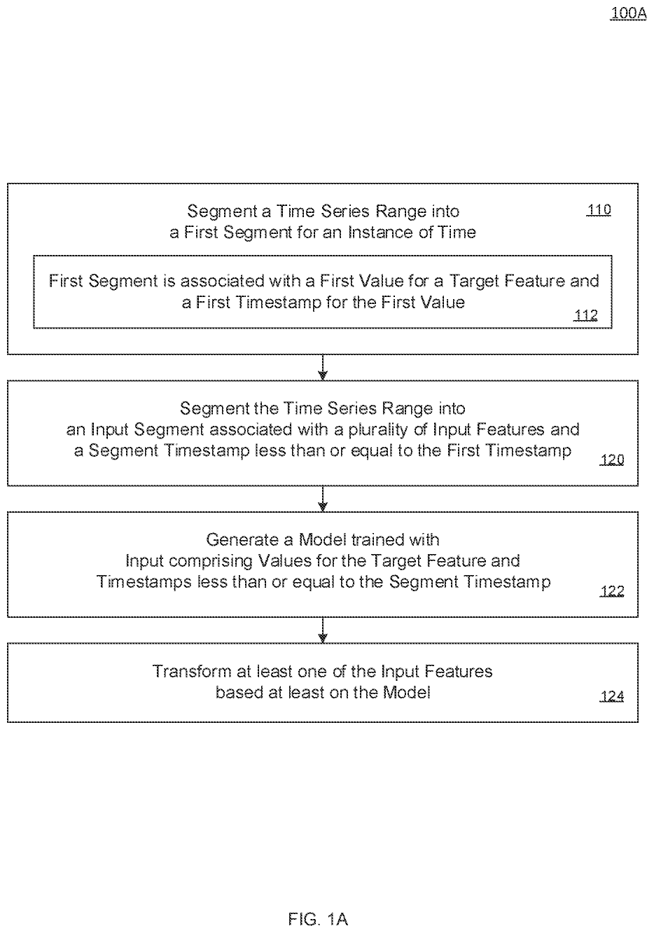

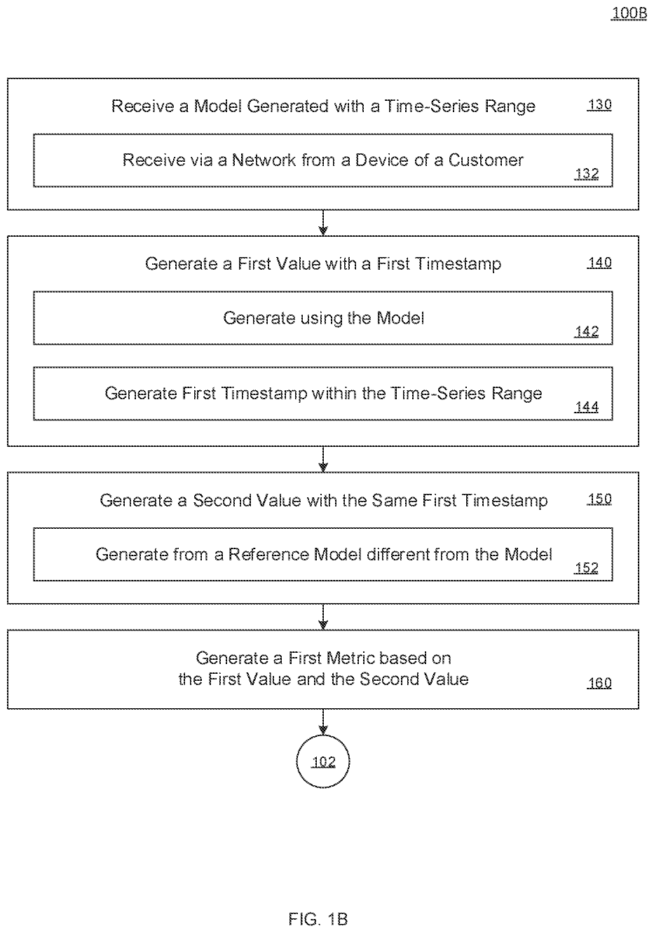

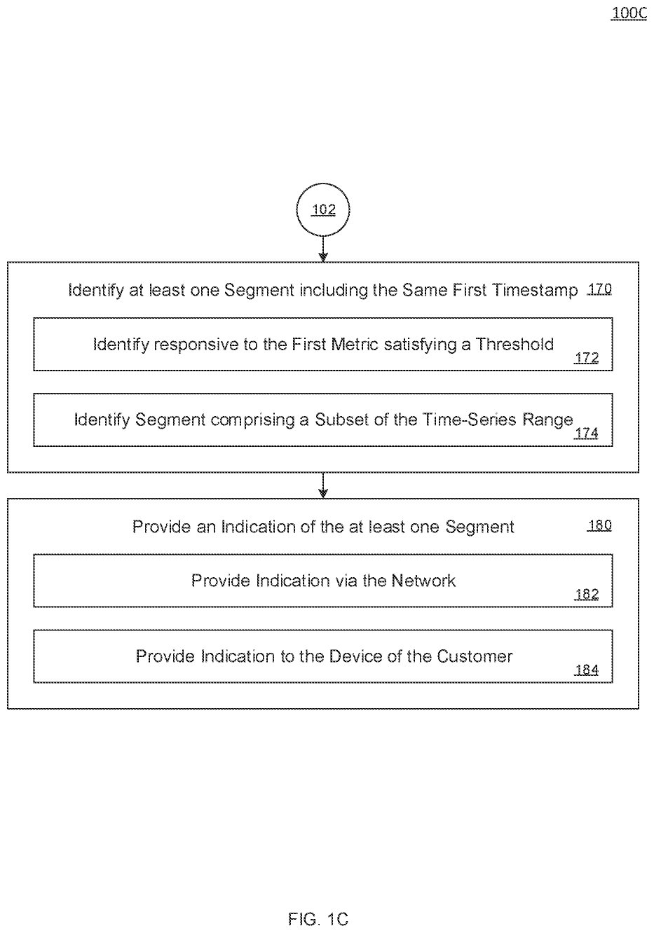

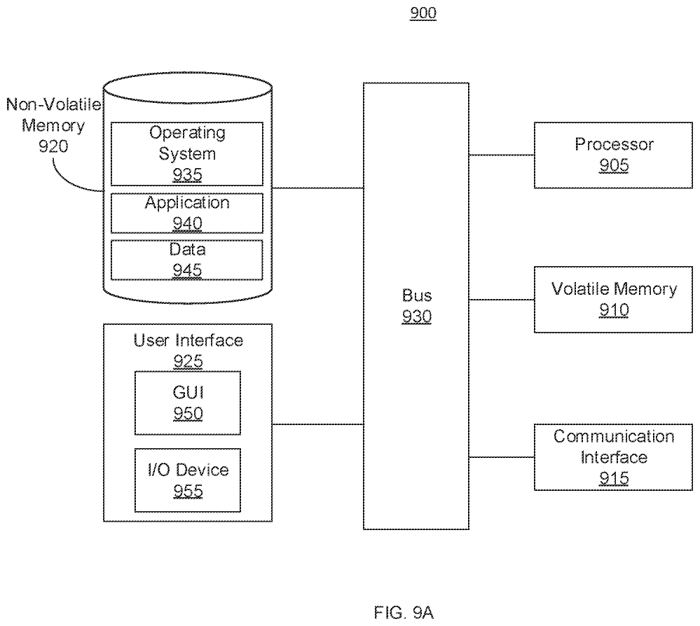

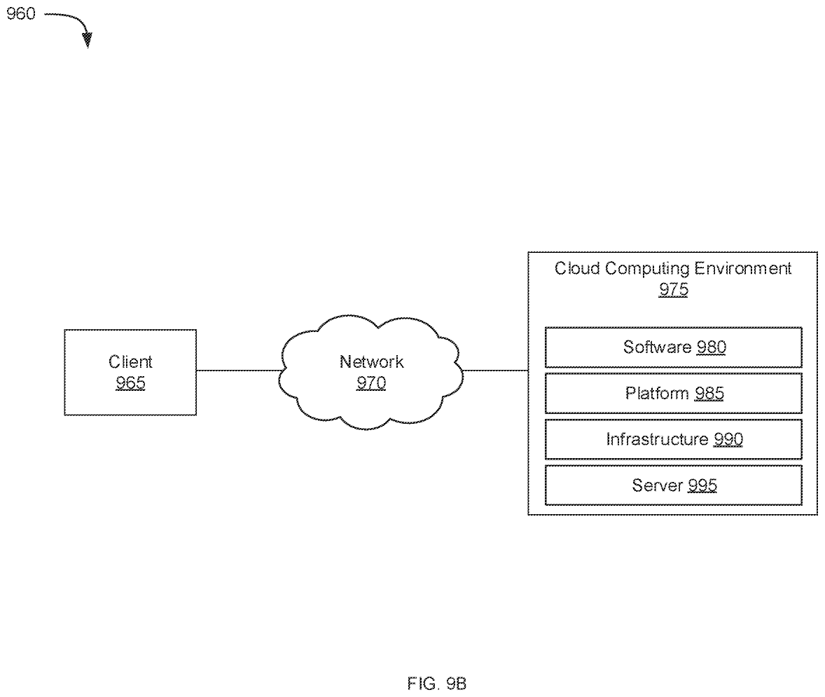

FIG. 1A illustrates a method for generating time series features using machine learning, in accordance with present implementations. One or more components or systems depicted in FIGS. 9A-16, including, for example, but not limited to, an operating system 935, an application 940, a user interface 925, a processor 905, a communication interface 915, a client 965, a network 970, a cloud computing environment 975, a user interface 1020, a modeling space exploration engine 1010, a model deployment engine 1040, a client 1410, a server 1450, processing nodes 1470, and worker clouds 1540, can perform method 100A according to present implementations.

At 110, the system can segment a time series range into a first segment for an instance of time. A segment can refer to or include a portion or subset of the time series range. In some cases, the segment can be the entire time series range. For example, and at 112, the system can segment the time-series range into a first segment associated with a first value for a target feature and a timestamp for the first value. The system can use one or more techniques to segment the time series range into the first segment. The system can obtain input used to segment the time-series range into segments that can correspond to a feature derivation window. The input can include, for example, one or more input affordances that can indicate an earliest timestamp and a latest timestamp associated with the feature derivation window. The timestamps can be absolute timestamps or relative timestamps relative to a current point in time. Generating a feature derivation window with relative timestamps can advantageously allow for real-time processing and modification of the machine learning engine.

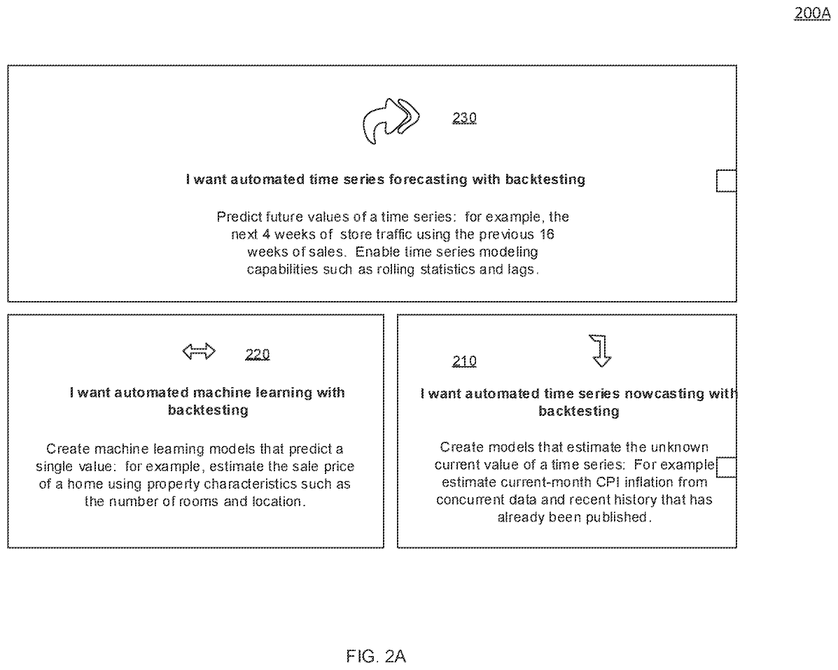

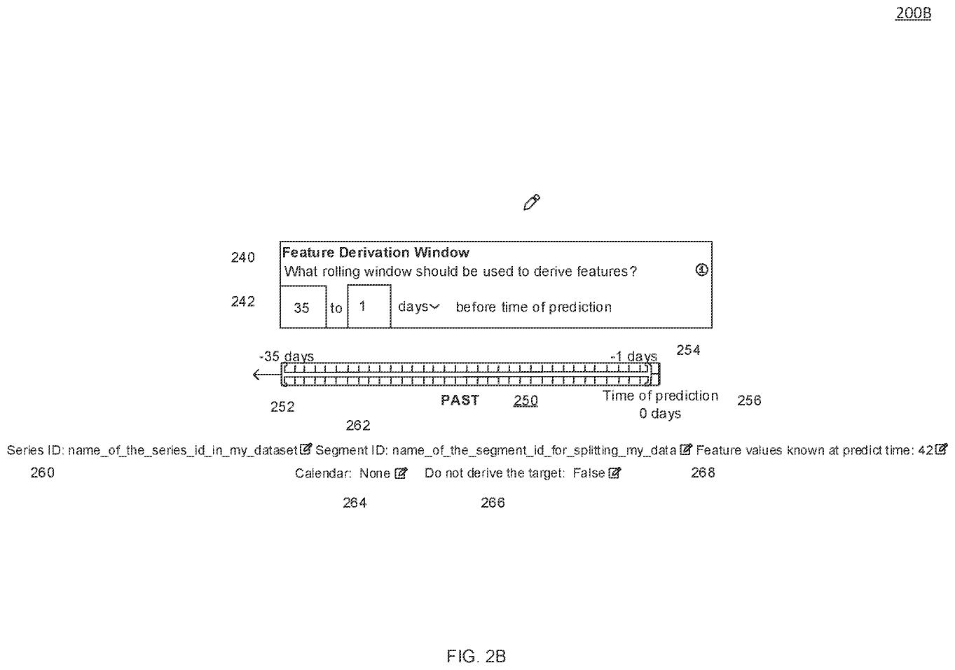

At 120, the system can segment the time series range into an input segment associated with multiple input features. The segment can have a segment timestamp that is less than or equal to the first timestamp. The first time stamp can be an earliest timestamp in the segment window, for example. The first timestamp can be relative first or earliest timestamp in the segment. As illustrated in FIG. 2B, the segment with the first timestamp can correspond to a feature derivation window that can include or correspond to a timeline that includes earlier timestamps to the left and later timestamps to the right.

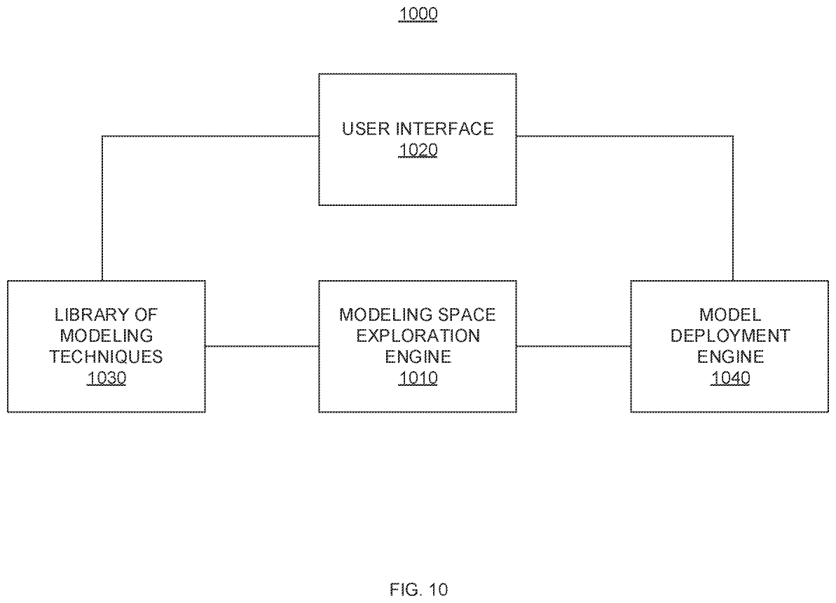

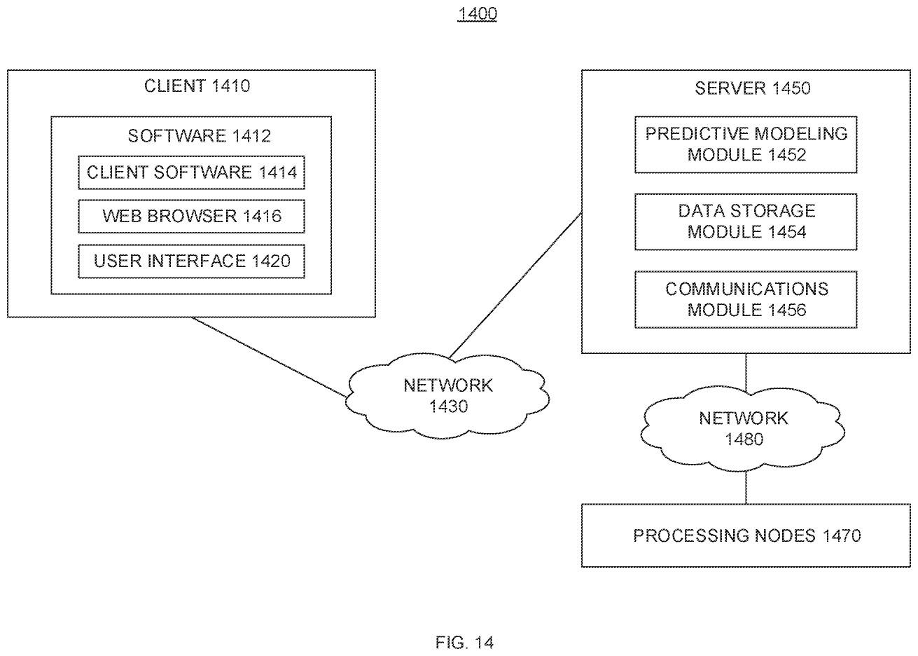

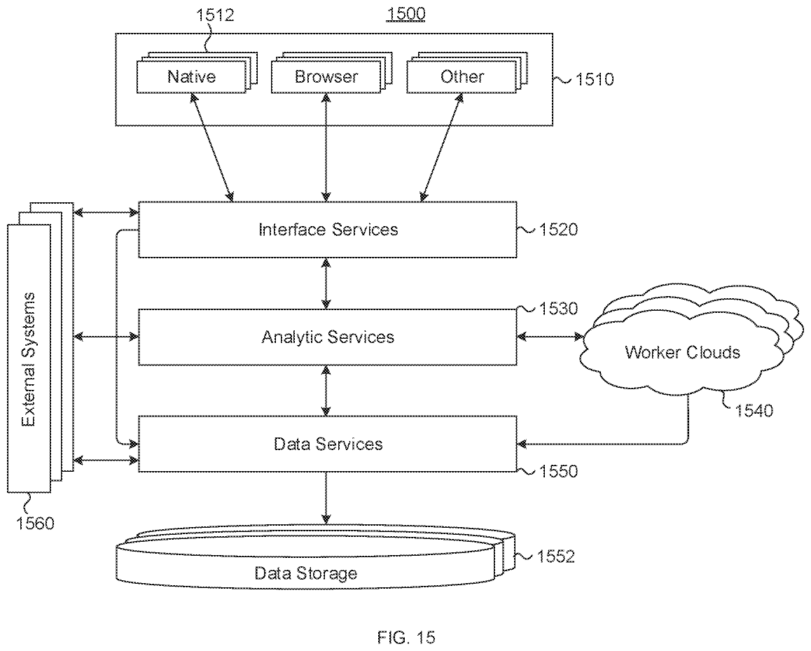

At 122, the system can generate a model. The model can be trained with input that includes values for the target feature and timestamps less than or equal to the segment timestamp. The system can train the model with the input values using one more machine learning techniques. For example, the system can use machine learning techniques provided by the system 1000 depicted in FIG. 10, system 1400 depicted in FIG. 14, or system 1500 depicted in FIG. 15.

At 124, the system can transform at least one of the input features. The system can transform the input feature based on the model. For example, the system can generate one or more impact metrics based on the model. The scalar value can indicate a degree of dependence of the current value of the target feature on a particular feature. Thus, the impact metric can quantitatively indicate how much impact a particular feature has on a current value of a target feature. The impact metric can be an absolute value with respect to a particular range, or can be a relative value with respect to one or more other input features or the target feature. The impact metric can thus provide a quantitative framework for ranking or filtering one or more features based on, for example, a correlation or dependence as discussed above. The system can use the impact metric to transform an input feature to include an indication based on the impact metric. For example, the system can use the impact metric generated based on the model to modify a value of the input feature.

FIGS. 1B-1C illustrate a method for validating a time series machine learning model output, in accordance with implementations. The methods 100B and 100C can be performed by one or more components or systems depicted in FIGS. 9A-16, including, for example, but not limited to, an operating system 935, an application 940, a user interface 925, a processor 905, a communication interface 915, a client 965, a network 970, a cloud computing environment 975, a user interface 1020, a modeling space exploration engine 1010, a model deployment engine 1040, a client 1410, a server 1450, processing nodes 1470, or worker clouds 1540.

At 130, the system can receive a model generated with a time-series range. For example, the system can receive the model via a network from a device of a customer. The system can provide a user interface, such as a graphical user interface, via which the customer can upload, identify, or otherwise provide access to the model. In some cases, the customer, using a customer device, can upload the model to the system via the user interface. In some cases, the customer can provide a reference or pointer to a location at which the model is stored, and authorize the system to access the model. The model can be generated by the customer using the customer device. In some cases, the model can be generated by another device associated with the customer device. For example, the customer can use a third-party model generation service to generate the model. The third-party model generation service can be different from the system.

At 140, the system can generate a first value with a first timestamp. For example, the system can generate the first value using the model received at step 130. The system can generate the first value using the model with a first timestamp that is within the time-series range, at step 144. To generate the first value using the model, the system can provide input to the model. For example, the system can input a first timestamp into the model in order to identify or generate the corresponding first value at that first timestamp.

At 150, the system can generate a second value with the same first timestamp. The system can generate the second value using a reference model that is different from the model received from the customer. The reference model can, for example, indicate a ground truth or otherwise be associated with a higher accuracy or likelihood of being more accurate. The reference model can be used as a reference. The reference model can be predetermined or generated by the system. The reference model can be generated using the same or different training as the model received from the customer, or using the same or different machine learning techniques. In some cases, the reference model can be generated using actual data or can be referred to as ground-truth data or known information. Thus, the system can generate a second value using the reference model that has the same timestamp that corresponds to the timestamp associated with the first value generated by the model. By generating values for the same timestamp using the model received from the customer and the reference model, the system can compare the different values to determine a metric.

At 160, the system can generate a first metric based on the first value and the second value. The system can compare the first value with the second value to generate the metric. The metric can include, for example, an error metric. The error metric can indicate a difference or amount of difference or be based on the difference between the first value generated using the model provided by the customer and the second value generated using the reference model.

At 170, depicted in FIG. 1C, the system can identify at least one segment including the same first timestamp. The system can identify the segment responsive to the first metric satisfying a threshold, at 172. For example, metric can be an error metric and the threshold can include an error threshold. In some cases, satisfying the error threshold can refer to the error metric being greater than or equal to the error threshold. In some cases, satisfying the error threshold can refer to the error metric being less than or equal to the error threshold. The system can identify the segment that includes a subset of the time-series range, at 174. For example, the segment can include a portion of the time-series range instead of the entire time-series range. The segment can include the portion of the time-series range that also includes the first timestamp. In some cases, the segment can include the entire time-series range.

At 180, the system can provide an indication of the at least one segment. For example, and at 182, the system can provide an indication via a network. The system can provide the indication to the device of the customer, at 184. The system can provide the indication of the segment that includes the portion of the time-series range that also includes the first timestamp responsive to the metric satisfying the threshold. The system can provide the indication of the segment to the device of the customer that previously uploaded the model. In some cases, the system can provide the indication of the segment to a different device associated with the customer. The indication can include the segment itself, or a reference to the segment that indicates the portion of subset of the time-series range that is used to form the segment.

The user interface 925 or 1020, or the GUI 950 can correspond to one or more of the user interfaces 200A and 300-800, and one or more of the operating system 935 and the I/O device 955 can generate the user interfaces 200A-B, 300, 400, 500, 600, 700, and 800.

FIG. 2A illustrates a user interface to generate a selection of a machine learning model, in accordance with present implementations. As illustrated by way of example in FIG. 2A, an example user interface 200A can include a first time series forecasting selection affordance 210, a machine learning output generator selection affordance 220, and a second time series forecasting selection affordance 230. Each of the control affordances 210, 220 and 230 can obtain a selection of a respective machine learning model operation, including a generating and validating operation as discussed herein.

As one example, a user has an option to choose a nowcasting mode by the affordance 210. In nowcasting mode, the machine learning system associated with the affordance 210 can perform nowcasting using one or more machine learning input configuration selections. Nowcasting can refer to or include predicting the present, the very near future, or the very recent past state, for example. One or more of the selection can be made by a user through one or more control affordance of the user interfaces of the system. The selection can include at least one of marking all features as known-in-advance, and obtaining a feature derivation window setting, obtaining a feature derivation window with a blind history gap. The system can obtain one or more features not know-in-advance, and can obtain a feature derivation window with a gap set to zero, or lacking a gap, for example. The gap can include a particular time range between a feature derivation window and a current time.

FIG. 2B depicts an example user interface to generate a time series model, in accordance with present implementations. As illustrated by way of example in FIG. 2B, an example user interface 200B can include a feature derivation selection window 240, a feature derivation window presentation 250, and one or more feature derivation window configuration selection affordances 260, 262, 264, 266 and 268.

The feature derivation selection window 240 can include one or more time series selection affordances 242 associated with the feature derivation window. The feature derivation selection window 240 can obtain input to segment the time-series range into a segment corresponding to the feature derivation window. The time series selection affordances 242 can include one or more input affordances to indicate an earliest timestamp and a latest timestamp associated with the feature derivation window. The timestamps can be absolute timestamps or relative timestamps relative to a current point in time. Generating a feature derivation window with relative timestamps can advantageously enable real-time processing and modification of the machine learning engine, by modifying and filtering inputs in accordance with a rolling window.

The feature derivation window presentation 250 can include a graphical presentation including a timeline including earlier timestamp to the left and later timestamp to the right. The presentation 250 can include an earliest timestamp presentation portion 252 indicating a position and value of an earliest timestamp in the feature derivation window. The presentation 250 can include a latest timestamp presentation portion 254 indicating a position and value of latest timestamp in the feature derivation window. The presentation 250 can include a current timestamp presentation portion 256 indicating a position and value of current timestamp corresponding to a current moment in time.

The feature derivation window configuration selection affordances 260, 262, 264, 266 and 268 can obtain selection of one or more inputs or modification to one or more inputs to the machine learning model to generate a time-series model. The affordances can include a series ID affordance 260, a segment ID affordance 262, a calendar affordance 264, a target derivation affordance 266, and a features values known at prediction time affordance 268.

As one example, a feature derivation window can be defined as FDW=[−n, −1], and a current timestamp can be defined as FW=[0]. The FDW end can be −1 instead of 0 when FW=[0]. Validation error from interference of values having timestamps within a particular time of the current timestamp can be reduced or eliminated by setting the latest timestamp of the feature derivation window to be less than the current timestamp. The magnitude of the difference between the latest timestamp and the current timestamp can be variable and can differ in terms of optimization based on the type and number of inputs or input series, for example, to the model.

As another example, the user interface 200 can cause the model to execute one or more test processes. A process can include a features derivation window defined by FDW=[−n, −1], and a current timestamp can be defined as FW=[0]. It is to be understood that configurations obtained by user interface can various be obtained by an application programming interface (“API”) or the like. Input can include a variety of blueprints and feature lists. Blueprints for FDW=[−n, −1], FW=[0] projects can correspond to a feature derivation window FDW=[−n, 0], and a current timestamp FW=[1], or FDW=[−n, −1], FW=[0], or FDW=[−n, 0], FW=[1]. The model can thus derive additional features such as lags, rolling statistics of target features and values. Thus, systems and methods of this technical solution can avoid, prevent, reduce, or minimize target leakage. Advantageously, this technical solution can provide scalable computational resources with forecast distance, for datasets and models associated with time series ranges.

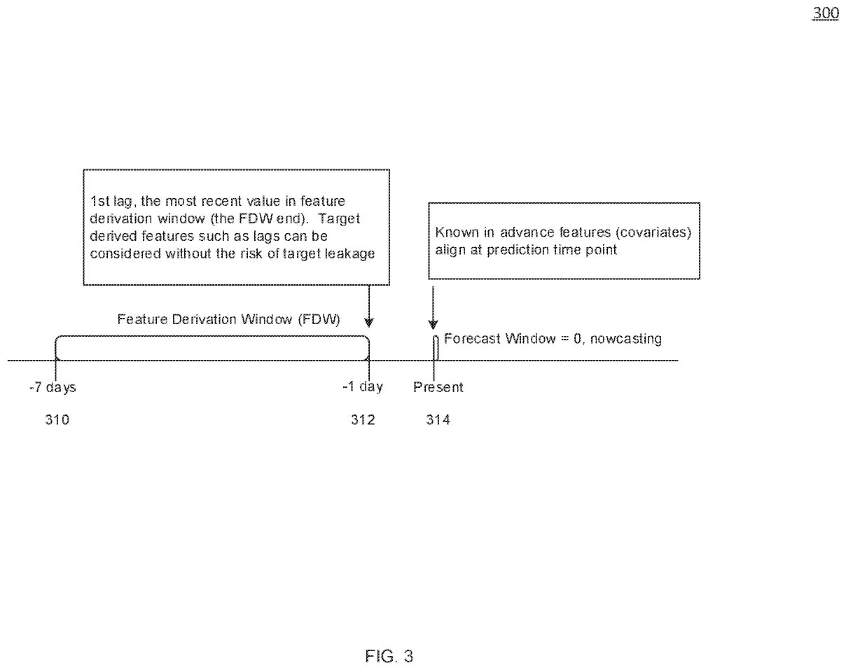

FIG. 3 illustrates a first example time-series range structure further to the example user interface of FIG. 2. As illustrated by way of example in FIG. 3, an example time series range structure can include an earliest feature derivation timestamp 310, a latest feature derivation timestamp 312, and a current timestamp 314. Each of the timestamps 310, 312 and 314 can correspond to timestamp associated with the affordances 222, 224 and 226. The first lag can correspond to the most recent value in the feature derivation window. Target derived features such as lags can be considered without the risk of target leakage. Known-in advance features can correspond to covariates, and align at the prediction time point.

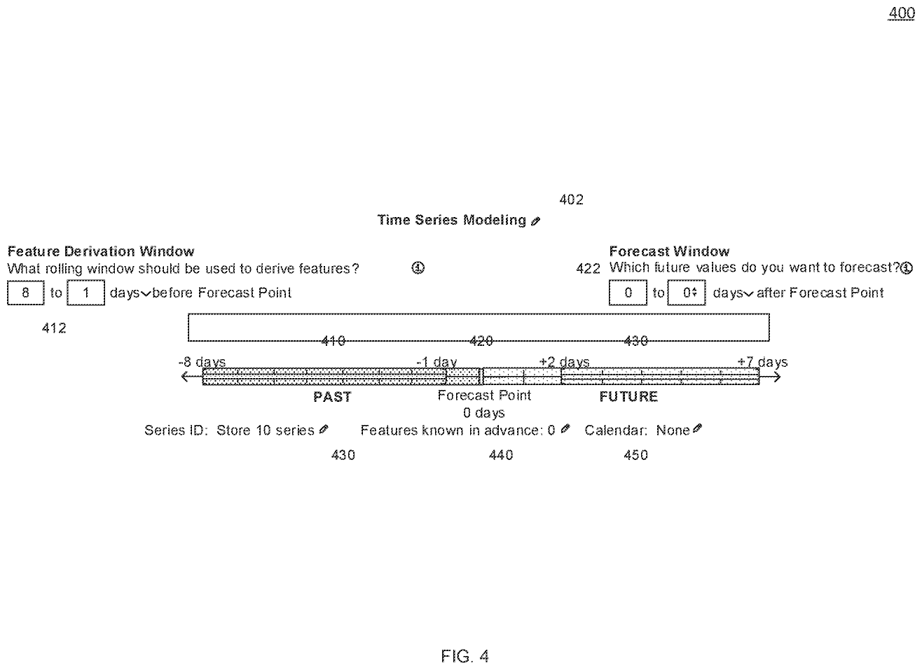

FIG. 4 is a second user interface to generate a time series model further to the example user interface of FIG. 2. As illustrated by way of example in FIG. 4, an example user interface 400 can include a time series modeling title presentation portion 402, a feature derivation selection window 412, a time-series range including a feature derivation window presentation portion 410, a current timestamp presentation portion 420, a future window presentation portion 430, and one or more feature derivation window configuration selection affordances 430, 440 and 450. The feature derivation selection window 412 can correspond at least partially in one or more of structure and operation to the feature derivation selection window 210. The feature derivation window presentation portion 410 can correspond at least partially in one or more of structure and operation to the feature derivation window presentation 220. The current timestamp presentation portion 420 can correspond at least partially in one or more of structure and operation to the current timestamp presentation portion 226. The feature derivation window configuration selection affordances 430, 440 and 450 can correspond at least partially in one or more of structure and operation to the affordances 230, 238 and 234, respectively.

The future window presentation portion 430 can include a graphical presentation including a timeline including earlier timestamp to the left and later timestamp to the right. The future window presentation portion 430 can include multiple timestamps each having values later than, or greater than, the current timestamp presentation portion, and can include an earliest timestamp presentation portion indicating a position and value of an earliest timestamp in the future window presentation portion 430. The future window presentation portion 430 can include a latest timestamp indicating a position and value of latest timestamp in the future window presentation portion 430.

In at least one aspect, the data processing system can generate a plurality of impact metrics associated with corresponding ones of the input features. The impact metrics can be based on the model, the first value, and input values. The impact metrics can include one or more scalar values each associated with a particular feature. The scalar value can indicate a quantitative degree of correlation of the particular feature with the current value of the target feature. The scalar value can indicate a degree of dependence of the current value of the target feature on a particular feature. Thus, the impact metric can quantitatively indicate how much impact a particular feature has on a current value of a target feature. The impact metric can be an absolute value with respect to a particular range, or can be a relative value with respect to one or more other input features or the target feature. The impact metric can thus provide a quantitative framework for ranking or filtering one or more features based on, for example, a correlation or dependence as discussed above.

In at least one aspect, the data processing system can transform at least one of the input features based on at least one of the impact metrics. The system can modify an aspect of a feature to include the impact metric or link to the impact metric for example. The input features can be transformed by modifying a presentation of the input features to include an indication based on the impact metrics. The input features can be transformed by modifying a value or a characteristic of the input features in view of the impact metric. As one example, the impact metric can be incorporated into an object including a feature by reference or value.

In at least one aspect, the data processing system can generate at least one user interface presentation including one or more of the transformed input features, in response to a determination that corresponding impact features associated with the one or more of the transformed input features satisfy an impact threshold. The system can generate one or more of the user interfaces 200A and 300-800 as discussed herein.

In at least one aspect, the data processing system can generate the model with input including the input features and the target feature. The system can advantageously include the target feature in the model to determine at least a current value of the target feature based on a previous value of the target feature. As one example, the target feature can include a quarterly GDP value, but not a current GDP value. The system can generate a current GDP value including a number of input features, and including one or more of the past quarterly GDP values associated with the target feature. Thus, in this example, the system can generate a current value of the target feature based at least partially on past quarterly values of the target feature.

In at least one aspect, at least one of the input timestamps is less than the first timestamp. A timestamp can be less than another timestamp where a scalar value of the timestamp is less than a scalar value of another timestamp. A scalar value can be a UNIX timestamp. It is to be understood that a timestamp that is less than another timestamp can be interchangeable with a timestamp that is earlier than another timestamp. It is to be understood that a timestamp that is greater than another timestamp can be interchangeable with a timestamp that is later than another timestamp. It is to be understood that a timestamp that is equal to another timestamp can be interchangeable with a timestamp that is at the same time as another timestamp. In at least one aspect, the first timestamp corresponds to a current time, and the segment timestamp corresponds to a past time.

In at least one aspect, the model is trained with input including the input features and the first value. As discussed above, the first value can correspond to a past value of the target feature.

In at least one aspect, each of the impact metrics are associated with respective ones of the input features. As discussed above, the impact metrics can include a plurality of impact metrics each individually associated with a corresponding one or the input features.

Implementations are directed to generating one or more metrics indicating accuracy performance a model with respect to one or more time-series ranges. The model can include an external model, third-party model, imported model, or remote model, for example. There is no constraint on the external time series model. The model can provide one or more of a prediction value, a forecast datetime, a forecast distance (e.g., number of time unit distance away from the forecast point), and a series ID (e.g., for multiseries model). Implementations can include validation of the external prediction file before an autopilot starts, and computation of one or more accuracy performance metrics scaled by the external predictions accuracy performance.

Validation of the external prediction file step can include determining whether sufficient samples exist with respect to the external model to make the comparison meaningful. Implementations can restrict validated models to models including samples within the backtest/holdout durations, which can be used to compute the performance metrics. Whenever the expected number of samples in validation/hold durations changes, revalidation of the external prediction dataset can be performed. Examples of revalidation include forecast window changes, validation duration changes, and holdout duration changes. In some implementations, only validated external prediction datasets are allowed to be used for comparison in autopilot.

A technical solution for generating scaled accuracy performance metrics can include, for example, extracting a common subset between project samples and external prediction samples, in terms of forecast datetime, forecast distance and, for a multiseries model, series ID, computing model accuracy performance by using the samples within the extracted subset, computing external predictions accuracy performance by using the samples within the extracted subset, and scaling the model accuracy performance by the external predictions accuracy performance. Thus, implementations can achieve technical advantages including overall scaled accuracy performance regardless of series ID & forecast distance, scaled accuracy performance per forecast distance, and scaled accuracy performance per series.

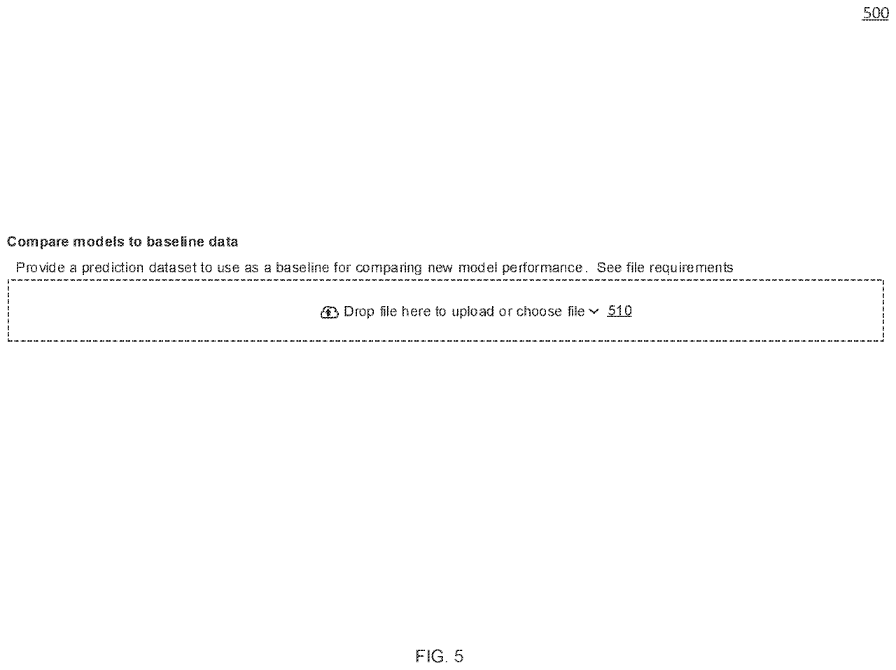

FIG. 5 is a first user interface to obtain a model, in accordance with present implementations. As illustrated by way of example in FIG. 5, an example user interface 500 can include at least one model input control affordance 510. The model input control affordance can obtain a selection of, for example, an address of, or a link to, a model. The model can include a machine learning model with a time-series component. The user interface can include a drag-and-drop interface, for example. It is to be understood that that the user interface can perform actions discussed as performed by the system, and the system can perform actions discussed as performed by the user interface.

As one example, the first user interface can obtain an upload of an external prediction dataset. The user interface then can upload or instruct the system to upload the dataset to an AI catalog first and then store a catalog ID. The user interface can then send a post request to validate the catalog. The system can then trigger an external prediction dataset validation job, and update validation logic to check validation corresponding to a particular validation duration period. The system can then add forecast distance related validation logic. The user interface can obtain a user selection from the user clicking “Start” once all other project parameters have been set. The user interface can start validation of the model in accordance with one or more aspects of the model. Once the external prediction dataset is validated, the user interface can send an aim request to the system. The aim request can contain the external prediction dataset catalog ID.

Continuing this example, the system can then evaluate the model. For each blueprint run, the system can check whether there is a need to compute external predictions related metrics, and can update metric computation to load required rows only into memory rather than loading the whole catalog dataset. The system can implement various validation logic, including but not limited to the following. After the user uploads the dataset to the AI catalog, the can validate rows that fall in validation & holdout durations. The catalog size can be determined explicitly to eliminate out of memory (OOM) errors when loading external prediction datasets into the memory. An example catalog size limit is around 10 GB. A limit between 2-5 GB can provide enough memory to operate the model and generate sufficient metrics related to the model. The greater the limit, the less memory room may be available when computing those external metrics.

TABLE 1

| Catalog | Estimated Row Numbers | Estimated Forecast Distance |
|---|---|---|
| File Size | (multiseries) | (Days) |
| 2 GB | 100M | 10 |
| 3 GB | 150M | 15 |
| 4 GB | 200M | 20 |
| 5 GB | 250M | 25 |

The system can then check whether there are missing rows in the external prediction dataset. Output can include, but is not limited to, the following scenarios. First, no missing rows found in the external prediction dataset. The system can then proceed with model analysis. Second, some missing rows found in the dataset. In response, the system can trigger warning and ask users whether to proceed or upload a new dataset. Third, validation can fail when more than 20% rows are missing. In response, an error message can be raised and the catalog id can be removed from this project. The catalog can still kept in AI Catalog, only catalog id are dissociated from the project.

The system can compute model accuracy. The system can retrieve the external predictions rows that fall in validation and holdout durations, and compute accuracy metrics using the intersection rows between external predictions internal model predictions.

In at least some aspects, the data processing system can segment the time-series range into the first segment and a second segment comprising a second subset of the time-series range that includes a second timestamp of the time-series range, in accordance with the determination that the first metric satisfies the threshold and a determination that a third metric associated with the second timestamp satisfies the threshold. The segmentation can include a first segment covering a first time range and a second segment covering a second time rage, as discussed above with respect to the example time segments generated to include, respectively, the second week and the fourth week of November.

In at least some aspects, the data processing system can generate, using the model, a third value with a third timestamp within the time-series range. In at least some aspects, the data processing system can extract a fourth value with the third timestamp from the reference model that is different from the model.

In at least some aspects, the data processing system can generate at least one second metric associated with the model and based on the first metric, and generate the second metric based on the third value and the fourth value. The second metric can include an aggregate metric indicating an accuracy of a model across a particular time range. The particular time range can include one or more segments having a range or length less than a total time series range or length associated with the dataset or the model under test.

In at least some aspects, the data processing system can extract a first object associated with the first value from the model, in accordance with a determination that the first value satisfies a filter threshold and in accordance with a determination that the second value satisfies the filter threshold. The first object can be a data point, or a calendar object, for example. The filter threshold can include a threshold for determining whether to include or exclude the value from one or more of the generation of the first metric and the generation of the second metric based on the first value. In at least some aspects, the data processing system can extract a first object associated with the first value from the model, in accordance with a determination that the first timestamp satisfies a timestamp threshold. The timestamp threshold can include a threshold for determining whether to include or exclude the value from one or more of the generation of the first metric and the generation of the second metric based on a value of the timestamp. In at least some aspects, the first metric comprises an error metric, and the second metric comprises an aggregate error metric. An error metric can be associated with a single timestamp, and an aggregate error metric can be associated with multiple timestamps or a time range, for example. In at least some aspects, the threshold comprises a predetermined error threshold.

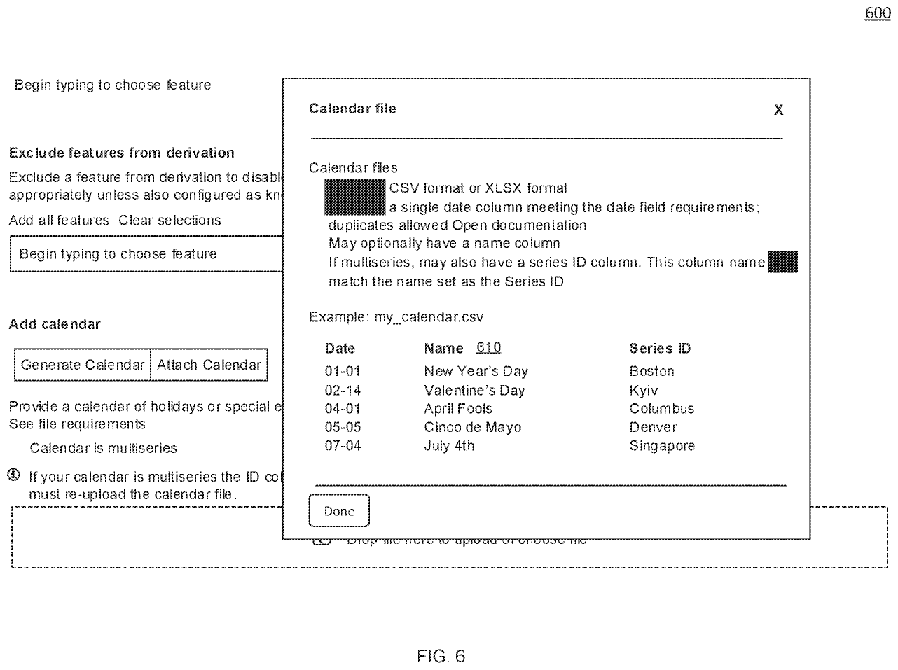

FIG. 6 is a second user interface to obtain a model further to the example user interface of FIG. 5. As illustrated by way of example in FIG. 6, an example user interface 600 can include a user interface format presentation portion 610. The user interface format presentation portion 610 can indicate one or more user interface formatting example or guidelines, for example, for a calendar file input object. The calendar file input object can include one or more calendar objects associated with one or more timestamps, datetime objects, data fields, metadata objects, and the like.

In at least one aspect, the data processing system can generate at least one user interface presentation including at least one calendar object associated with the time series structure. The calendar object can be generated periodically, in accordance with a repetition pattern determined by a machine learning model and including one or more of the input features. A calendar object can be generate, for example, at each timestamp indicating a convergence of one or more values of one or more features with respect to one or more thresholds.

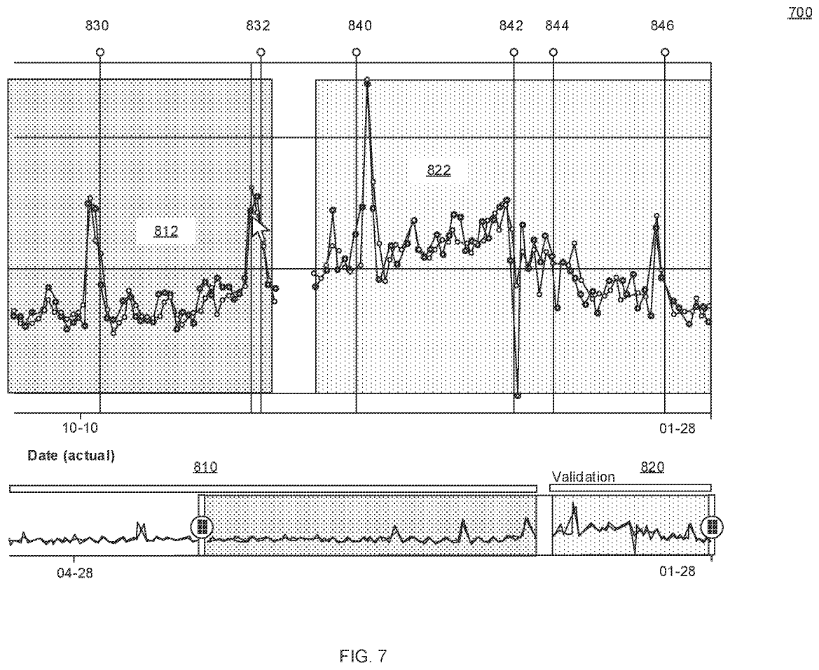

FIG. 7 is a first user interface to present output according to a time-series model, in accordance with present implementations. As illustrated by way of example in FIG. 7, an example user interface 700 can include a forecast window 810, a magnified forecast window 812, a validation window 820, a magnified validation window 822, a plurality of calendar timestamps 830 and 832 associated with the forecast window 810, and a plurality of calendar timestamps 842, 844 and 846 associated with the validation window 820.

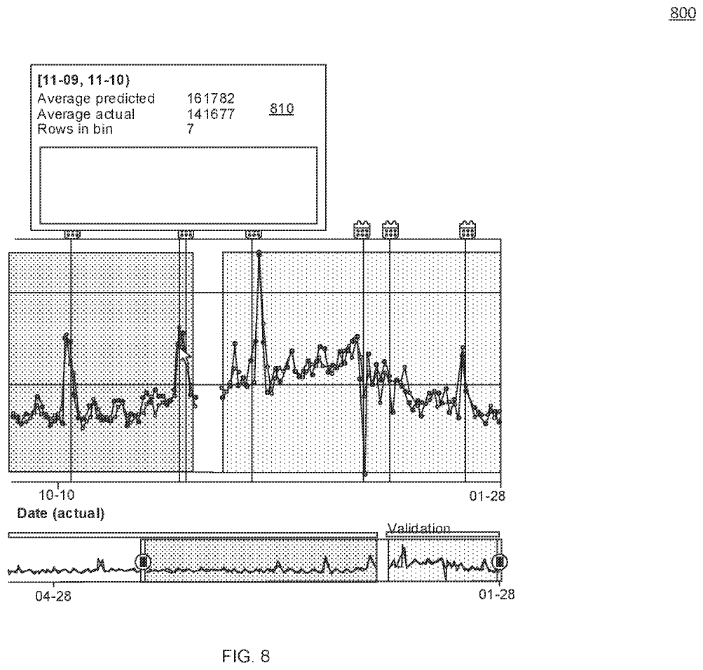

FIG. 8 is a second user interface to present output according to a time-series model further to the example user interface of FIG. 7. As illustrated by way of example in FIG. 8, an example user interface 800 can include the forecast window 810, the magnified forecast window 812, the validation window 820, the magnified validation window 822, the plurality of calendar timestamps 830 and 832 associated with the forecast window 810, the plurality of calendar timestamps 842, 844 and 846 associated with the validation window 820.

### B. Computing Environment

FIGS. 9A-9B depict example computing environments that form, perform, or otherwise provide or facilitate systems and methods of epidemiological modeling using machine learning. FIG. 9A illustrates an example computer 900, which can include one or more processors 905, volatile memory 910 (e.g., random access memory (RAM)), non-volatile memory 920 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 925, one or more communications interfaces 915, and communication bus 930. User interface 925 may include graphical user interface (GUI) 950 (e.g., a touchscreen, a display, etc.) and one or more input/output (I/O) devices 955 (e.g., a mouse, a keyboard, a microphone, one or more speakers, one or more cameras, one or more biometric scanners, one or more environmental sensors, one or more accelerometers, etc.).

Non-volatile memory 920 can store operating system 935, one or more applications 940, and data 945 such that, for example, computer instructions of operating system 935 and/or applications 940 are executed by processor(s) 905 out of volatile memory 910. In some implementations, volatile memory 910 may include one or more types of RAM and/or a cache memory that may offer a faster response time than a main memory. Data may be entered using an input device of GUI 950 or received from I/O device(s) 955. Various elements of computer 900 may communicate via one or more communication buses, shown as communication bus 930.

Clients, servers, and other components or devices on a network can be implemented by any computing or processing environment and with any type of machine or set of machines that may have suitable hardware and/or software capable of operating as described herein. Processor(s) 905 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some implementations, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some implementations, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 915 may include one or more interfaces to enable computer 900 to access a computer network such as a Local Area Network (LAN), a Wide Area Network (WAN), a Personal Area Network (PAN), or the Internet through a variety of wired and/or wireless or cellular connections.

The computing device 900 may execute an application on behalf of a user of a client computing device. The computing device 900 can provide virtualization features, including, for example, hosting a virtual machine. The computing device 900 may also execute a terminal services session to provide a hosted desktop environment. The computing device 900 may provide access to a computing environment including one or more of: one or more applications, one or more desktop applications, and one or more desktop sessions in which one or more applications may execute.

FIG. 9B depicts an example computing environment 960. Computing environment 960 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 960 can provide the delivery of shared services (e.g., computer services) and shared resources (e.g., computer resources) to multiple users. For example, the computing environment 960 can include an environment or system for providing or delivering access to a plurality of shared services and resources to a plurality of users through the internet. The shared resources and services can include, but not limited to, networks, network bandwidth, servers 995, processing, memory, storage, applications, virtual machines, databases, software, hardware, analytics, and intelligence.

In implementations, the computing environment 960 may provide client 965 with one or more resources provided by a network environment. The computing environment 960 may include one or more clients 965, in communication with a cloud 975 over a network 970. The cloud 975 may include back end platforms, e.g., servers 995, storage, server farms or data centers. The clients 965 can include one or more component or functionality of computer 900 depicted in FIG. 9A.

The users or clients 965 can correspond to a single organization or multiple organizations. For example, the computing environment 960 can include a private cloud serving a single organization (e.g., enterprise cloud). The computing environment 960 can include a community cloud or public cloud serving multiple organizations. In implementations, the computing environment 960 can include a hybrid cloud that is a combination of a public cloud and a private cloud. For example, the cloud 975 may be public, private, or hybrid. Public clouds 975 may include public servers 995 that are maintained by third parties to the clients 965 or the owners of the clients 965. The servers 995 may be located off-site in remote geographical locations as disclosed above or otherwise. Public clouds 975 may be connected to the servers 995 over a public network 970. Private clouds 975 may include private servers 995 that are physically maintained by clients 965 or owners of clients 965. Private clouds 975 may be connected to the servers 995 over a private network 970. Hybrid clouds 975 may include both the private and public networks 970 and servers 995.

The cloud 975 may include back end platforms, e.g., servers 995, storage, server farms or data centers. For example, the cloud 975 can include or correspond to a server 995 or system remote from one or more clients 965 to provide third party control over a pool of shared services and resources. The computing environment 960 can provide resource pooling to serve multiple users via clients 965 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users.

In some implementations, the computing environment 960 can include and provide different types of cloud computing services. For example, the computing environment 960 can include Infrastructure as a service (IaaS). The computing environment 960 can include Platform as a service (PaaS). The computing environment 960 can include server-less computing. The computing environment 960 can include Software as a service (SaaS). For example, the cloud 975 may also include a cloud based delivery, e.g. Software as a Service (SaaS) 980, Platform as a Service (PaaS) 985, and Infrastructure as a Service (IaaS) 990. IaaS may refer to a user renting the use of infrastructure resources that are needed during a specified time period. IaaS providers may offer storage, networking, servers or virtualization resources from large pools, allowing the users to quickly scale up by accessing more resources as needed. PaaS providers may offer functionality provided by IaaS, including, e.g., storage, networking, servers or virtualization, as well as additional resources such as, e.g., the operating system, middleware, or runtime resources. SaaS providers may offer the resources that PaaS provides, including storage, networking, servers, virtualization, operating system, middleware, or runtime resources. In some implementations, SaaS providers may offer additional resources including, e.g., data and application resources.

Clients 965 may access IaaS resources with one or more IaaS standards. Some IaaS standards may allow clients access to resources over HTTP, and may use Representational State Transfer (REST) protocol or Simple Object Access Protocol (SOAP). Clients 965 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 965 may access SaaS resources through the use of web-based user interfaces, provided by a web browser. Clients 965 may also access SaaS resources through smartphone or tablet applications. Clients 965 may also access SaaS resources through the client operating system.

In some implementations, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### C. Predictive Modeling System

With respect at least to implementations of epidemiologic modeling using machine learning, an overview of a predictive modeling system is provided. A predictive modeling system for use Data analysts can use analytic techniques and computational infrastructures to build predictive models from electronic data, including operations and evaluation data. Data analysts generally use one of two approaches to build predictive models. With the first approach, an organization dealing with a prediction problem simply uses a packaged predictive modeling solution already developed for the same prediction problem or a similar prediction problem. This “cookie cutter” approach, though inexpensive, is generally viable only for a small number of prediction problems (e.g., fraud detection, churn management, marketing response, etc.) that are common to a relatively large number of organizations. With the second approach, a team of data analysts builds a customized predictive modeling solution for a prediction problem. This “artisanal” approach is generally expensive and time-consuming, and therefore tends to be used for a small number of high-value prediction problems.

The space of potential predictive modeling solutions for a prediction problem is generally large and complex. Statistical learning techniques are influenced by many academic traditions (e.g., mathematics, statistics, physics, engineering, economics, sociology, biology, medicine, artificial intelligence, data mining, etc.) and by applications in many areas of commerce (e.g., finance, insurance, retail, manufacturing, healthcare, etc.). Consequently, there are many different predictive modeling algorithms, which may have many variants and/or tuning parameters, as well as different pre-processing and post-processing steps with their own variants and/or parameters. The volume of potential predictive modeling solutions (e.g., combinations of pre-processing steps, modeling algorithms, and post-processing steps) is already quite large and is increasing rapidly as researchers develop new techniques.

Given this vast space of predictive modeling techniques, some approaches, such as the artisanal approach, to generating predictive models tend to be time-consuming and to leave large portions of the modeling search space unexplored. Analysts tend to explore the modeling space in an ad hoc fashion, based on their intuition or previous experience and on extensive trial-and-error testing. They may not pursue some potentially useful avenues of exploration or adjust their searches properly in response to the results of their initial efforts. Furthermore, the scope of the trial-and-error testing tends to be limited by constraints on the analysts' time, such that the artisanal approach generally explores only a small portion of the modeling search space.

The artisanal approach can also be very expensive. Developing a predictive model via the artisanal approach often entails a substantial investment in computing resources and in well-paid data analysts. In view of these substantial costs, organizations often forego the artisanal approach in favor of the cookie cutter approach, which can be less expensive, but tends to explore only a small portion of this vast predictive modeling space (e.g., a portion of the modeling space that is expected, a priori, to contain acceptable solutions to a specified prediction problem). The cookie cutter approach can generate predictive models that perform poorly relative to unexplored options.

Thus, systems and methods of this technical solution can systematically and cost-effectively evaluate the space of potential predictive modeling techniques for prediction problems. This technical solution can utilize statistical learning techniques to systematically and cost-effectively evaluate the space of potential predictive modeling solutions for prediction problems.

Referring to FIG. 10, in some implementations a predictive modeling system 1000 includes a predictive modeling exploration engine 1010, a user interface 1020, a library 1030 of predictive modeling techniques, and a predictive model deployment engine 1040. The system 1000 and its components can include one or more component or functionality depicted in FIGS. 9A-9B. The exploration engine 1010 may implement a search technique (or “modeling methodology”) for efficiently exploring the predictive modeling search space (e.g., potential combinations of pre-processing steps, modeling algorithms, and post-processing steps) to generate a predictive modeling solution suitable for a specified prediction problem. The search technique may include an initial evaluation of which predictive modeling techniques are likely to provide suitable solutions for the prediction problem. In some implementations, the search technique includes an incremental evaluation of the search space (e.g., using increasing fractions of a dataset), and a consistent comparison of the suitability of different modeling solutions for the prediction problem (e.g., using consistent metrics). In some implementations, the search technique adapts based on results of prior searches, which can improve the effectiveness of the search technique over time.

The exploration engine 1010 may use the library 1030 of modeling techniques to evaluate potential modeling solutions in the search space. In some implementations, the modeling technique library 1030 includes machine-executable templates encoding complete modeling techniques. A machine-executable template may include one or more predictive modeling algorithms. In some implementations, the modeling algorithms included in a template may be related in some way. For example, the modeling algorithms may be variants of the same modeling algorithm or members of a family of modeling algorithms. In some implementations, a machine-executable template further includes one or more pre-processing and/or post-processing steps suitable for use with the template's algorithm(s). The algorithm(s), pre-processing steps, and/or post-processing steps may be parameterized. A machine-executable template may be applied to a user dataset to generate potential predictive modeling solutions for the prediction problem represented by the dataset.

The exploration engine 1010 may uses the computational resources of a distributed computing system to explore the search space or portions thereof. In some implementations, the exploration engine 1010 generates a search plan for efficiently executing the search using the resources of the distributed computing system, and the distributed computing system executes the search in accordance with the search plan. The distributed computing system may provide interfaces that facilitate the evaluation of predictive modeling solutions in accordance with the search plan, including, without limitation, interfaces for queuing and monitoring of predictive modeling techniques, for virtualization of the computing system's resources, for accessing databases, for partitioning the search plan and allocating the computing system's resources to evaluation of modeling techniques, for collecting and organizing execution results, for accepting user input, etc.

The user interface 1020 provides tools for monitoring and/or guiding the search of the predictive modeling space. These tools may provide insight into a prediction problem's dataset (e.g., by highlighting problematic variables in the dataset, identifying relationships between variables in the dataset, etc.), and/or insight into the results of the search. In some implementations, data analysts may use the interface to guide the search, e.g., by specifying the metrics to be used to evaluate and compare modeling solutions, by specifying the criteria for recognizing a suitable modeling solution, etc. Thus, the user interface may be used by analysts to improve their own productivity, and/or to improve the performance of the exploration engine 1010. In some implementations, user interface 1020 presents the results of the search in real-time, and permits users to guide the search (e.g., to adjust the scope of the search or the allocation of resources among the evaluations of different modeling solutions) in real-time. In some implementations, user interface 1020 provides tools for coordinating the efforts of multiple data analysts working on the same prediction problem and/or related prediction problems.

In some implementations, the user interface 1020 provides tools for developing machine-executable templates for the library 1030 of modeling techniques. System users may use these tools to modify existing templates, to create new templates, or to remove templates from the library 1030. In this way, system users may update the library 1030 to reflect advances in predictive modeling research, and/or to include proprietary predictive modeling techniques.

The model deployment engine 1040 provides tools for deploying predictive models in operational environments (e.g., predictive models generated by exploration engine 1010). In some implementations, the model deployment engine also provides tools for monitoring and/or updating predictive models. System users may use the deployment engine 1040 to deploy predictive models generated by exploration engine 1010, to monitor the performance of such predictive models, and to update such models (e.g., based on new data or advancements in predictive modeling techniques). In some implementations, exploration engine 1010 may use data collected and/or generated by deployment engine 1040 (e.g., based on results of monitoring the performance of deployed predictive models) to guide the exploration of a search space for a prediction problem (e.g., to re-fit or tune a predictive model in response to changes in the underlying dataset for the prediction problem).

The system can include a library of modeling techniques. Library 1030 of predictive modeling techniques includes machine-executable templates encoding complete predictive modeling techniques. In some implementations, a machine-executable template includes one or more predictive modeling algorithms, zero or more pre-processing steps suitable for use with the algorithm(s), and zero or more post-processing steps suitable for use with the algorithm(s). The algorithm(s), pre-processing steps, and/or post-processing steps may be parameterized. A machine-executable template may be applied to a dataset to generate potential predictive modeling solutions for the prediction problem represented by the dataset.

A template may encode, for machine execution, pre-processing steps, model-fitting steps, and/or post-processing steps suitable for use with the template's predictive modeling algorithm(s). Examples of pre-processing steps include, without limitation, imputing missing values, feature engineering (e.g., one-hot encoding, splines, text mining, etc.), feature selection (e.g., dropping uninformative features, dropping highly correlated features, replacing original features by top principal components, etc.). Examples of model-fitting steps include, without limitation, algorithm selection, parameter estimation, hyper-parameter tuning, scoring, diagnostics, etc. Examples of post-processing steps include, without limitation, calibration of predictions, censoring, blending, etc.

In some implementations, a machine-executable template includes metadata describing attributes of the predictive modeling technique encoded by the template. The metadata may indicate one or more data processing techniques that the template can perform as part of a predictive modeling solution (e.g., in a pre-processing step, in a post-processing step, or in a step of predictive modeling algorithm). These data processing techniques may include, without limitation, text mining, feature normalization, dimension reduction, or other suitable data processing techniques. Alternatively or in addition, the metadata may indicate one or more data processing constraints imposed by the predictive modeling technique encoded by the template, including, without limitation, constraints on dimensionality of the dataset, characteristics of the prediction problem's target(s), and/or characteristics of the prediction problem's feature(s).

In some implementations, a template's metadata includes information relevant to estimating how well the corresponding modeling technique will work for a given dataset. For example, a template's metadata may indicate how well the corresponding modeling technique is expected to perform on datasets having particular characteristics, including, without limitation, wide datasets, tall datasets, sparse datasets, dense datasets, datasets that do or do not include text, datasets that include variables of various data types (e.g., numerical, ordinal, categorical, interpreted (e.g., date, time, text), etc.), datasets that include variables with various statistical properties (e.g., statistical properties relating to the variable's missing values, cardinality, distribution, etc.), etc. As another example, a template's metadata may indicate how well the corresponding modeling technique is expected to perform for a prediction problem involving target variables of a particular type. In some implementations, a template's metadata indicates the corresponding modeling technique's expected performance in terms of one or more performance metrics (e.g., objective functions).

In some implementations, a template's metadata includes characterizations of the processing steps implemented by the corresponding modeling technique, including, without limitation, the processing steps' allowed data type(s), structure, and/or dimensionality.

In some implementations, a template's metadata includes data indicative of the results (actual or expected) of applying the predictive modeling technique represented by the template to one or more prediction problems and/or datasets. The results of applying a predictive modeling technique to a prediction problem or dataset may include, without limitation, the accuracy with which predictive models generated by the predictive modeling technique predict the target(s) of the prediction problem or dataset, the rank of accuracy of the predictive models generated by the predictive modeling technique (relative to other predictive modeling techniques) for the prediction problem or dataset, a score representing the utility of using the predictive modeling technique to generate a predictive model for the prediction problem or dataset (e.g., the value produced by the predictive model for an objective function), etc.

The data indicative of the results of applying a predictive modeling technique to a prediction problem or dataset may be provided by exploration engine 1010 (e.g., based on the results of previous attempts to use the predictive modeling technique for the prediction problem or the dataset), provided by a user (e.g., based on the user's expertise), and/or obtained from any other suitable source. In some implementations, exploration engine 1010 updates such data based, at least in part, on the relationship between actual outcomes of instances of a prediction problem and the outcomes predicted by a predictive model generated via the predictive modeling technique.

In some implementations, a template's metadata describes characteristics of the corresponding modeling technique relevant to estimating how efficiently the modeling technique will execute on a distributed computing infrastructure. For example, a template's metadata may indicate the processing resources needed to train and/or test the modeling technique on a dataset of a given size, the effect on resource consumption of the number of cross-validation folds and the number of points searched in the hyper-parameter space, the intrinsic parallelization of the processing steps performed by the modeling technique, etc.

In some implementations, the library 1030 of modeling techniques includes tools for assessing the similarities (or differences) between predictive modeling techniques. Such tools may express the similarity between two predictive modeling techniques as a score (e.g., on a predetermined scale), a classification (e.g., “highly similar”, “somewhat similar”, “somewhat dissimilar”, “highly dissimilar”), a binary determination (e.g., “similar” or “not similar”), etc. Such tools may determine the similarity between two predictive modeling techniques based on the processing steps that are common to the modeling techniques, based on the data indicative of the results of applying the two predictive modeling techniques to the same or similar prediction problems, etc. For example, given two predictive modeling techniques that have a large number (or high percentage) of their processing steps in common and/or yield similar results when applied to similar prediction problems, the tools may assign the modeling techniques a high similarity score or classify the modeling techniques as “highly similar”.

In some implementations, the modeling techniques may be assigned to families of modeling techniques. The familial classifications of the modeling techniques may be assigned by a user (e.g., based on intuition and experience), assigned by a machine-learning classifier (e.g., based on processing steps common to the modeling techniques, data indicative of the results of applying different modeling techniques to the same or similar problems, etc.), or obtained from another suitable source. The tools for assessing the similarities between predictive modeling techniques may rely on the familial classifications to assess the similarity between two modeling techniques. In some implementations, the tool may treat all modeling techniques in the same family as “similar” and treat any modeling techniques in different families as “not similar”. In some implementations, the familial classifications of the modeling techniques may be just one factor in the tool's assessment of the similarity between modeling techniques.

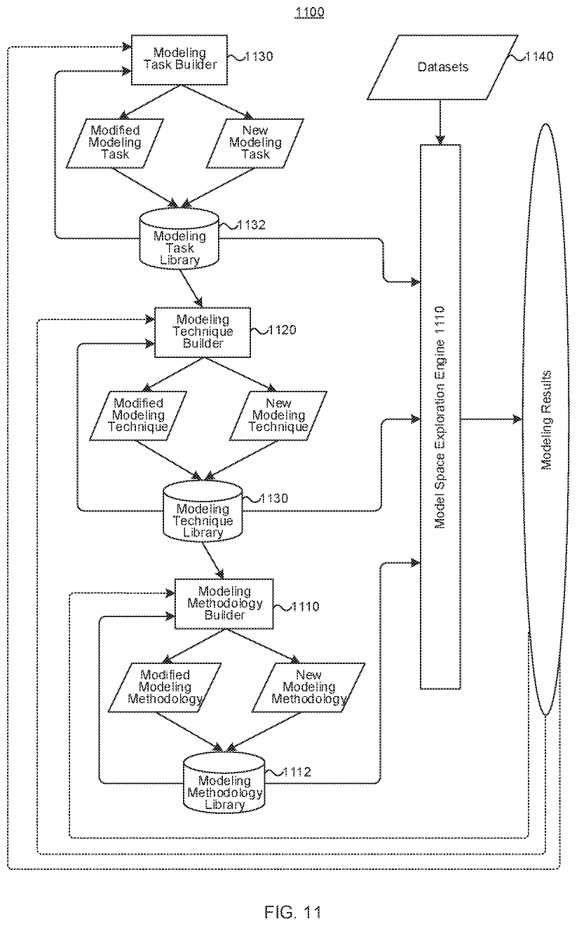

In some implementations, predictive modeling system 1100 includes a library of prediction problems (not shown in FIG. 11). The library of prediction problems may include data indicative of the characteristics of prediction problems. In some implementations, the data indicative of the characteristics of prediction problems includes data indicative of characteristics of datasets representing the prediction problem. Characteristics of a dataset may include, without limitation, the dataset's width, height, sparseness, or density; the number of targets and/or features in the dataset, the data types of the data set's variables (e.g., numerical, ordinal, categorical, or interpreted (e.g., date, time, text, etc.); the ranges of the dataset's numerical variables; the number of classes for the dataset's ordinal and categorical variables; etc.

In some implementations, characteristics of a dataset include statistical properties of the dataset's variables, including, without limitation, the number of total observations; the number of unique values for each variable across observations; the number of missing values of each variable across observations; the presence and extent of outliers and inliers; the properties of the distribution of each variable's values or class membership; cardinality of the variables; etc. In some implementations, characteristics of a dataset include relationships (e.g., statistical relationships) between the dataset's variables, including, without limitation, the joint distributions of groups of variables; the variable importance of one or more features to one or more targets (e.g., the extent of correlation between feature and target variables); the statistical relationships between two or more features (e.g., the extent of multicollinearity between two features); etc.

In some implementations, the data indicative of the characteristics of the prediction problems includes data indicative of the subject matter of the prediction problem (e.g., finance, insurance, defense, e-commerce, retail, internet-based advertising, internet-based recommendation engines, etc.); the provenance of the variables (e.g., whether each variable was acquired directly from automated instrumentation, from human recording of automated instrumentation, from human measurement, from written human response, from verbal human response, etc.); the existence and performance of known predictive modeling solutions for the prediction problem; etc.

In some implementations, predictive modeling system 1100 may support time-series prediction problems (e.g., uni-dimensional or multi-dimensional time-series prediction problems). For time-series prediction problems, the objective is generally to predict future values of the targets as a function of prior observations of all features, including the targets themselves. The data indicative of the characteristics of a prediction problem may accommodate time-series prediction problems by indicating whether the prediction problem is a time-series prediction problem, and by identifying the time measurement variable in datasets corresponding to time-series prediction problems.

In some implementations, the library of prediction problems includes tools for assessing the similarities (or differences) between prediction problems. Such tools may express the similarity between two prediction problems as a score (e.g., on a predetermined scale), a classification (e.g., “highly similar”, “somewhat similar”, “somewhat dissimilar”, “highly dissimilar”), a binary determination (e.g., “similar” or “not similar”), etc. Such tools may determine the similarity between two prediction problems based on the data indicative of the characteristics of the prediction problems, based on data indicative of the results of applying the same or similar predictive modeling techniques to the prediction problems, etc. For example, given two prediction problems represented by datasets that have a large number (or high percentage) of characteristics in common and/or are susceptible to the same or similar predictive modeling techniques, the tools may assign the prediction problems a high similarity score or classify the prediction problems as “highly similar”.

FIG. 11 illustrates a block diagram of a modeling tool 1100 suitable for building machine-executable templates encoding predictive modeling techniques and for integrating such templates into predictive modeling methodologies, in accordance with some implementations. User interface 1020 may provide an interface to modeling tool 1100.

In the example of FIG. 11, a modeling methodology builder 1110 builds a library 1112 of modeling methodologies on top of a library 1030 of modeling techniques. A modeling technique builder 1120 builds the library 1030 of modeling techniques on top of a library 1132 of modeling tasks. A modeling methodology may correspond to one or more analysts' intuition about and experience of what modeling techniques work well in which circumstances, and/or may leverage results of the application of modeling techniques to previous prediction problems to guide exploration of the modeling search space for a prediction problem. A modeling technique may correspond to a step-by-step recipe for applying a specific modeling algorithm. A modeling task may correspond to a processing step within a modeling technique.

In some implementations, a modeling technique may include a hierarchy of tasks. For example, a top-level “text mining” task may include sub-tasks for (a) creating a document-term matrix and (b) ranking terms and dropping terms that may be unimportant or that are not to be weighted or considered as highly. In turn, the “term ranking and dropping” sub-task may include sub-tasks for (b.1) building a ranking model and (b.2) using term ranks to drop columns from a document-term matrix. Such hierarchies may have arbitrary depth.

In the example of FIG. 11, modeling tool 1100 includes a modeling task builder 1130, a modeling technique builder 1120, and a modeling methodology builder 1110. Each builder may include a tool or set of tools for encoding one of the modeling elements in a machine-executable format. Each builder may permit users to modify an existing modeling element or create a new modeling element. To construct a complete library of modeling elements across the modeling layers illustrated in FIG. 11, developers may employ a top-down, bottom-up, inside-out, outside-in, or combination strategy. However, from the perspective of logical dependency, leaf-level tasks are the smallest modeling elements, so FIG. 11 depicts task creation as the first step in the process of constructing machine-executable templates.

Each builder's user interface may be implemented using, without limitation, a collection of specialized routines in a standard programming language, a formal grammar designed specifically for the purpose of encoding that builder's elements, a rich user interface for abstractly specifying the desired execution flow, etc. However, the logical structure of the operations allowed at each layer is independent of any particular interface.

When creating modeling tasks at the leaf level in the hierarchy, modeling tool 1100 may permit developers to incorporate software components from other sources. This capability leverages the installed base of software related to statistical learning and the accumulated knowledge of how to develop such software. This installed base covers scientific programming languages, scientific routines written in general purpose programming languages (e.g., C), scientific computing extensions to general-purpose programming languages (e.g., scikit-learn for Python), commercial statistical environments (e.g., SAS/STAT), and open source statistical environments (e.g., R). When used to incorporate the capabilities of such a software component, the modeling task builder 1130 may require a specification of the software component's inputs and outputs, and/or a characterization of what types of operations the software component can perform. In some implementations, the modeling task builder 1130 generates this metadata by inspecting a software component's source code signature, retrieving the software components' interface definition from a repository, probing the software component with a sequence of requests, or performing some other form of automated evaluation. In some implementations, the developer manually supplies some or all of this metadata.

In some implementations, the modeling task builder 1130 uses this metadata to create a “wrapper” that allows it to execute the incorporated software. The modeling task builder 1130 may implement such wrappers utilizing any mechanism for integrating software components, including, without limitation, compiling a component's source code into an internal executable, linking a component's object code into an internal executable, accessing a component through an emulator of the computing environment expected by the component's standalone executable, accessing a component's functions running as part of a software service on a local machine, accessing a components functions running as part of a software service on a remote machine, accessing a component's function through an intermediary software service running on a local or remote machine, etc. No matter which incorporation mechanism the modeling task builder 1130 uses, after the wrapper has been generated, modeling tool 1100 may make software calls to the component as it would any other routine.

In some implementations, developers may use the modeling task builder 1130 to assemble leaf-level modeling tasks recursively into higher-level tasks. As indicated previously, there are many different ways to implement the user interface for specifying the arrangement of the task hierarchy. But from a logical perspective, a task that is not at the leaf-level may include a directed graph of sub-tasks. At each of the top and intermediate levels of this hierarchy, there may be one starting sub-task whose input is from the parent task in the hierarchy (or the parent modeling technique at the top level of the hierarchy). There may also be one ending sub-task whose output is to the parent task in the hierarchy (or the parent modeling technique at the top level of the hierarchy). Every other sub-task at a given level may receive inputs from one or more previous sub-tasks and sends outputs to one or more subsequent sub-tasks.

Combined with the ability to incorporate arbitrary code in leaf-level tasks, propagating data according to the directed graph facilitates implementation of arbitrary control flows within an intermediate-level task. In some implementations, modeling tool 1100 may provide additional built-in operations. For example, while it would be straightforward to implement any particular conditional logic as a leaf-level task coded in an external programming language, the modeling task builder 1130 may provide a built-in node or arc that performs conditional evaluations in a general fashion, directing some or all of the data from a node to different subsequent nodes based on the results of these evaluations. Similar alternatives exist for filtering the output from one node according to a rule or expression before propagating it as input to subsequent nodes, transforming the output from one node before propagating it as input to subsequent nodes, partitioning the output from one node according to a rule or expression before propagating each partition to a respective subsequent node, combining the output of multiple previous nodes according to a rule or formula before accepting it as input, iteratively applying a sub-graph of nodes' operations using one or more loop variables, etc.

In some implementations, developers may use the modeling technique builder 1120 to assemble tasks from the modeling task library 1132 into modeling techniques. At least some of the modeling tasks in modeling task library 1132 may correspond to the pre-processing steps, model-fitting steps, and/or post-processing steps of one or more modeling techniques. The development of tasks and techniques may follow a linear pattern, in which techniques are assembled after the task library 1132 is populated, or a more dynamic, circular pattern, in which tasks and techniques are assembled concurrently. A developer may be inspired to combine existing tasks into a new technique, realize that this technique requires new tasks, and iteratively refine until the new technique is complete. Alternatively, a developer may start with the conception of a new technique, perhaps from an academic publication, begin building it from new tasks, but pull existing tasks from the modeling task library 1132 when they provide suitable functionality. In all cases, the results from applying a modeling technique to reference datasets or in field tests will allow the developer or analyst to evaluate the performance of the technique. This evaluation may, in turn, result in changes anywhere in the hierarchy from leaf-level modeling task to modeling technique. By providing common modeling task and modeling technique libraries (1132, 1030) as well as high productivity builder interfaces (1110, 1120, and 1130), modeling tool 1100 may enable developers to make changes rapidly and accurately, as well as propagate such enhancements to other developers and users with access to the libraries (1132, 1130).

A modeling technique may provide a focal point for developers and analysts to conceptualize an entire predictive modeling procedure, with all the steps expected based on the best practices in the field. In some implementations, modeling techniques encapsulate best practices from statistical learning disciplines. Moreover, the modeling tool 1100 can provide guidance in the development of high-quality techniques by, for example, providing a checklist of steps for the developer to consider and comparing the task graphs for new techniques to those of existing techniques to, for example, detect missing tasks, detect additional steps, and/or detect anomalous flows among steps.

In some implementations, exploration engine 1010 is used to build a predictive model for a dataset 1140 using the techniques in the modeling technique library 1030. The exploration engine 1010 may prioritize the evaluation of the modeling techniques in modeling technique library 1030 based on a prioritization scheme encoded by a modeling methodology selected from the modeling methodology library 1112. Examples of suitable prioritization schemes for exploration of the modeling space are described in the next section. In the example of FIG. 11, results of the exploration of the modeling space may be used to update the metadata associated with modeling tasks and techniques.

In some implementations, unique identifiers (IDs) may be assigned to the modeling elements (e.g., techniques, tasks, and sub-tasks). The ID of a modeling element may be stored as metadata associated with the modeling element's template. In some implementations, these modeling element IDs may be used to efficiently execute modeling techniques that share one or more modeling tasks or sub-tasks. Methods of efficiently executing modeling techniques are described in further detail below.

In the example of FIG. 11, the modeling results produced by exploration engine 1010 are fed back to the modeling task builder 1130, the modeling technique builder 1120, and the modeling methodology builder 1110. The modeling builders may be adapted automatically (e.g., using a statistical learning algorithm) or manually (e.g., by a user) based on the modeling results. For example, modeling methodology builder 1110 may be adapted based on patterns observed in the modeling results and/or based on a data analyst's experience. Similarly, results from executing specific modeling techniques may inform automatic or manual adjustment of default tuning parameter values for those techniques or tasks within them. In some implementations, the adaptation of the modeling builders may be semi-automated. For example, predictive modeling system 1000 may flag potential improvements to methodologies, techniques, and/or tasks, and a user may decide whether to implement those potential improvements.

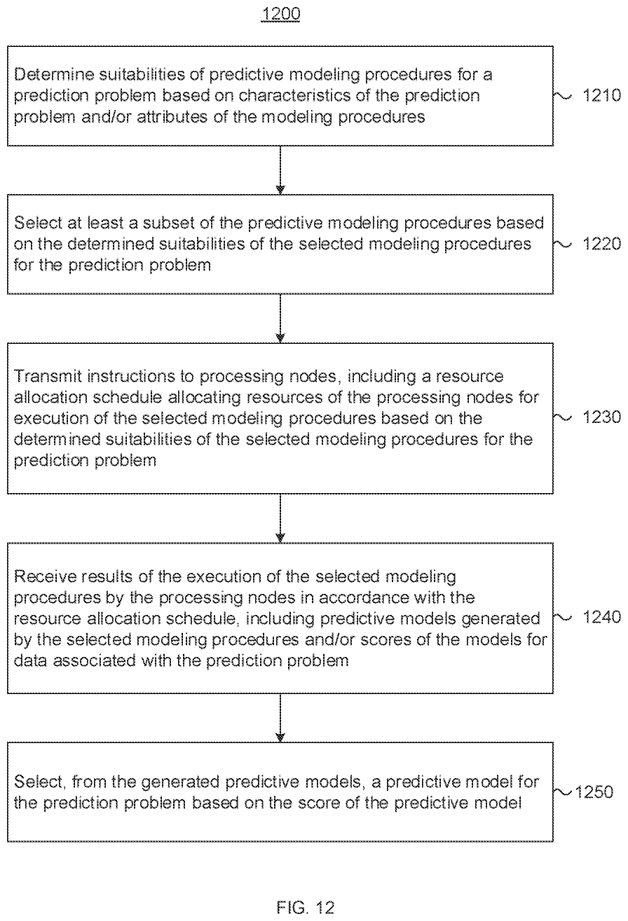

The technical solution can include or utilize a modeling space exploration engine. FIG. 12 is a flowchart of a method 1200 for selecting a predictive model for a prediction problem, in accordance with some implementations. In some implementations, method 1200 may correspond to a modeling methodology in the modeling methodology library 1112.

At step 1210 of method 1200, the suitability of a plurality of predictive modeling procedures (e.g., predictive modeling techniques) for a prediction problem are determined. A predictive modeling procedure's suitability for a prediction problem may be determined based on characteristics of the prediction problem, based on attributes of the modeling procedures, and/or based on other suitable information.

The “suitability” of a predictive modeling procedure for a prediction problem may include data indicative of the expected performance on the prediction problem of predictive models generated using the predictive modeling procedure. In some implementations, a predictive model's expected performance on a prediction problem includes one or more expected scores (e.g., expected values of one or more objective functions) and/or one or more expected ranks (e.g., relative to other predictive models generated using other predictive modeling techniques).

Alternatively or in addition, the “suitability” of a predictive modeling procedure for a prediction problem may include data indicative of the extent to which the modeling procedure is expected to generate predictive models that provide adequate performance for a prediction problem. In some implementations, a predictive modeling procedure's “suitability” data includes a classification of the modeling procedure's suitability. The classification scheme may have two classes (e.g., “suitable” or “not suitable”) or more than two classes (e.g., “highly suitable”, “moderately suitable”, “moderately unsuitable”, “highly unsuitable”).

In some implementations, exploration engine 1010 determines the suitability of a predictive modeling procedure for a prediction problem based, at least in part, on one or more characteristics of the prediction problem, including (but not limited to) characteristics described herein. As just one example, the suitability of a predictive modeling procedure for a prediction problem may be determined based on characteristics of the dataset corresponding to the prediction problem, characteristics of the variables in the dataset corresponding to the prediction problem, relationships between the variables in the dataset, and/or the subject matter of the prediction problem. Exploration engine 1010 may include tools (e.g., statistical analysis tools) for analyzing datasets associated with prediction problems to determine the characteristics of the prediction problems, the datasets, the dataset variables, etc.

In some implementations, exploration engine 1010 determines the suitability of a predictive modeling procedure for a prediction problem based, at least in part, on one or more attributes of the predictive modeling procedure, including (but not limited to) the attributes of predictive modeling procedures described herein. As just one example, the suitability of a predictive modeling procedure for a prediction problem may be determined based on the data processing techniques performed by the predictive modeling procedure and/or the data processing constraints imposed by the predictive modeling procedure.

In some implementations, determining the suitability of the predictive modeling procedures for the prediction problem comprises eliminating at least one predictive modeling procedure from consideration for the prediction problem. The decision to eliminate a predictive modeling procedure from consideration may be referred to herein as “pruning” the eliminated modeling procedure and/or “pruning the search space”. In some implementations, the user can override the exploration engine's decision to prune a modeling procedure, such that the previously pruned modeling procedure remains eligible for further execution and/or evaluation during the exploration of the search space.

A predictive modeling procedure may be eliminated from consideration based on the results of applying one or more deductive rules to the attributes of the predictive modeling procedure and the characteristics of the prediction problem. The deductive rules may include, without limitation, the following: (1) if the prediction problem includes a categorical target variable, select only classification techniques for execution; (2) if numeric features of the dataset span vastly different magnitude ranges, select or prioritize techniques that provide normalization; (3) if a dataset has text features, select or prioritize techniques that provide text mining; (4) if the dataset has more features than observations, eliminate all techniques that require the number of observations to be greater than or equal to the number of features; (5) if the width of the dataset exceeds a threshold width, select or prioritize techniques that provide dimension reduction; (6) if the dataset is large and sparse (e.g., the size of the dataset exceeds a threshold size and the sparseness of the dataset exceeds a threshold sparseness), select or prioritize techniques that execute efficiently on sparse data structures; and/or any rule for selecting, prioritizing, or eliminating a modeling technique wherein the rule can be expressed in the form of an if-then statement. In some implementations, deductive rules are chained so that the execution of several rules in sequence produces a conclusion. In some implementations, the deductive rules may be updated, refined, or improved based on historical performance.

In some implementations, exploration engine 1010 determines the suitability of a predictive modeling procedure for a prediction problem based on the performance (expected or actual) of similar predictive modeling procedures on similar prediction problems. (As a special case, exploration engine 1010 may determine the suitability of a predictive modeling procedure for a prediction problem based on the performance (expected or actual) of the same predictive modeling procedure on similar prediction problems.)

As described above, the library of modeling techniques 1030 may include tools for assessing the similarities between predictive modeling techniques, and the library of prediction problems may include tools for assessing the similarities between prediction problems. Exploration engine 1010 may use these tools to identify predictive modeling procedures and prediction problems similar to the predictive modeling procedure and prediction problem at issue. For purposes of determining the suitability of a predictive modeling procedure for a prediction problem, exploration engine 1010 may select the M modeling procedures most similar to the modeling procedure at issue, select all modeling procedures exceeding a threshold similarity value with respect to the modeling procedure at issue, etc. Likewise, for purposes of determining the suitability of a predictive modeling procedure for a prediction problem, exploration engine 1010 may select the N prediction problems most similar to the prediction problem at issue, select all prediction problems exceeding a threshold similarity value with respect to the prediction problem at issue, etc.

Given a set of predictive modeling procedures and a set of prediction problems similar to the modeling procedure and prediction problem at issue, exploration engine may combine the performances of the similar modeling procedures on the similar prediction problems to determine the expected suitability of the modeling procedure at issue for the prediction problem at issue. As described above, the templates of modeling procedures may include information relevant to estimating how well the corresponding modeling procedure will perform for a given dataset. Exploration engine 1010 may use the model performance metadata to determine the performance values (expected or actual) of the similar modeling procedures on the similar prediction problems. These performance values can then be combined to generate an estimate of the suitability of the modeling procedure at issue for the prediction problem at issue. For example, exploration engine 1010 may calculate the suitability of the modeling procedure at issue as a weighted sum of the performance values of the similar modeling procedures on the similar prediction problems.

In some implementations, exploration engine 1010 determines the suitability of a predictive modeling procedure for a prediction problem based, at least in part, on the output of a “meta” machine-learning model, which may be trained to determine the suitability of a modeling procedure for a prediction problem based on the results of various modeling procedures (e.g., modeling procedures similar to the modeling procedure at issue) for other prediction problems (e.g., prediction problems similar to the prediction problem at issue). The machine-learning model for estimating the suitability of a predictive modeling procedure for a prediction problem may be referred to as a “meta” machine-learning model because it applies machine learning recursively to predict which techniques are most likely to succeed for the prediction problem at issue. Exploration engine 1010 may therefore produce meta-predictions of the suitability of a modeling technique for a prediction problem by using a meta-machine-learning algorithm trained on the results from solving other prediction problems.

In some implementations, exploration engine 1010 may determine the suitability of a predictive modeling procedure for a prediction problem based, at least in part, on user input (e.g., user input representing the intuition or experience of data analysts regarding the predictive modeling procedure's suitability).

Returning to FIG. 12, at step 1220 of method 1200, at least a subset of the predictive modeling procedures may be selected based on the suitability of the modeling procedures for the prediction problem. In implementations where the modeling procedures have been assigned to suitability categories (e.g., “suitable” or “not suitable”; “highly suitable”, “moderately suitable”, “moderately unsuitable”, or “highly unsuitable”; etc.), selecting a subset of the modeling procedures may comprise selecting the modeling procedures assigned to one or more suitability categories (e.g., all modeling procedures assigned to the “suitable category”; all modeling procedures not assigned to the “highly unsuitable” category; etc.).

In implementations where the modeling procedures have been assigned suitability values, exploration engine 1010 may select a subset of the modeling procedures based on the suitability values. In some implementations, exploration engine 1010 selects the modeling procedures with suitability scores above a threshold suitability score. The threshold suitability score may be provided by a user or determined by exploration engine 1010. In some implementations, exploration engine 1010 may adjust the threshold suitability score to increase or decrease the number of modeling procedures selected for execution, depending on the amount of processing resources available for execution of the modeling procedures.

In some implementations, exploration engine 1010 selects the modeling procedures with suitability scores within a specified range of the highest suitability score assigned to any of the modeling procedures for the prediction problem at issue. The range may be absolute (e.g., scores within S points of the highest score) or relative (e.g., scores within P % of the highest score). The range may be provided by a user or determined by exploration engine 1010. In some implementations, exploration engine 1010 may adjust the range to increase or decrease the number of modeling procedures selected for execution, depending on the amount of processing resources available for execution of the modeling procedures.

In some implementations, exploration engine 1010 selects a fraction of the modeling procedures having the highest suitability scores for the prediction problem at issue. Equivalently, the exploration engine 1010 may select the fraction of the modeling procedures having the highest suitability ranks (e.g., in cases where the suitability scores for the modeling procedures are not available, but the ordering (ranking) of the modeling procedures' suitability is available). The fraction may be provided by a user or determined by exploration engine 1010. In some implementations, exploration engine 1010 may adjust the fraction to increase or decrease the number of modeling procedures selected for execution, depending on the amount of processing resources available for execution of the modeling procedures.

In some implementations, a user may select one or more modeling procedures to be executed. The user-selected procedures may be executed in addition to or in lieu of one or more modeling procedures selected by exploration engine 1010. Allowing the users to select modeling procedures for execution may improve the performance of predictive modeling system 1000, particularly in scenarios where a data analyst's intuition and experience indicate that the modeling system 1000 has not accurately estimated a modeling procedure's suitability for a prediction problem.

In some implementations, exploration engine 1010 may control the granularity of the search space evaluation by selecting a modeling procedure P0 that is representative of (e.g., similar to) one or more other modeling procedures P1 . . . PN, rather than selecting modeling procedures P0 . . . PN, even if modeling procedures P0 . . . PN are all determined to be suitable for the prediction problem at issue. In addition, exploration engine 1010 may treat the results of executing the selected modeling procedure P0 as being representative of the results of executing the modeling procedures P1 . . . PN. This coarse-grained approach to evaluating the search space may conserve processing resources, particularly if applied during the earlier stages of the evaluation of the search space. If exploration engine 1010 later determines that modeling procedure P0 is among the most suitable modeling procedures for the prediction problem, a fine-grained evaluation of the relevant portion of the search space can then be performed by executing and evaluating the similar modeling procedures P1 . . . PN.

Returning to FIG. 12, at step 1230 of method 1200, a resource allocation schedule may be generated. The resource allocation schedule may allocate processing resources for the execution of the selected modeling procedures. In some implementations, the resource allocation schedule allocates the processing resources to the modeling procedures based on the determined suitability of the modeling procedures for the prediction problem at issue. In some implementations, exploration engine 1010 transmits the resource allocation schedule to one or more processing nodes with instructions for executing the selected modeling procedures according to the resource allocation schedule.

The allocated processing resources may include temporal resources (e.g., execution cycles of one or more processing nodes, execution time on one or more processing nodes, etc.), physical resources (e.g., a number of processing nodes, an amount of machine-readable storage (e.g., memory and/or secondary storage), etc.), and/or other allocable processing resources. In some implementations, the allocated processing resources may be processing resources of a distributed computing system and/or a cloud-based computing system. In some implementations, costs may be incurred when processing resources are allocated and/or used (e.g., fees may be collected by an operator of a data center in exchange for using the data center's resources).

As indicated above, the resource allocation schedule may allocate processing resources to modeling procedures based on the suitability of the modeling procedures for the prediction problem at issue. For example, the resource allocation schedule may allocate more processing resources to modeling procedures with higher predicted suitability for the prediction problem, and allocate fewer processing resources to modeling procedures with lower predicted suitability for the prediction problem, so that the more promising modeling procedures benefit from a greater share of the limited processing resources. As another example, the resource allocation schedule may allocate processing resources sufficient for processing larger datasets to modeling procedures with higher predicted suitability, and allocate processing resources sufficient for processing smaller datasets to modeling procedures with lower predicted suitability.

As another example, the resource allocation schedule may schedule execution of the modeling procedures with higher predicted suitability prior to execution of the modeling procedures with lower predicted suitability, which may also have the effect of allocating more processing resources to the more promising modeling procedures. In some implementations, the results of executing the modeling procedures may be presented to the user via user interface 1020 as the results become available. In such implementations, scheduling the modeling procedures with higher predicted suitability to execute before the modeling procedures with lower predicted suitability may provide the user with additional information about the evaluation of the search space at an earlier phase of the evaluation, thereby facilitating rapid user-driven adjustments to the search plan. For example, based on the preliminary results, the user may determine that one or more modeling procedures that were expected to perform very well are actually performing very poorly. The user may investigate the cause of the poor performance and determine, for example, that the poor performance is caused by an error in the preparation of the dataset. The user can then fix the error and restart execution of the modeling procedures that were affected by the error.

In some implementations, the resource allocation schedule may allocate processing resources to modeling procedures based, at least in part, on the resource utilization characteristics and/or parallelism characteristics of the modeling procedures. As described above, the template corresponding to a modeling procedure may include metadata relevant to estimating how efficiently the modeling procedure will execute on a distributed computing infrastructure. In some implementations, this metadata includes an indication of the modeling procedure's resource utilization characteristics (e.g., the processing resources needed to train and/or test the modeling procedure on a dataset of a given size). In some implementations, this metadata includes an indication of the modeling procedure's parallelism characteristics (e.g., the extent to which the modeling procedure can be executed in parallel on multiple processing nodes). Using the resource utilization characteristics and/or parallelism characteristics of the modeling procedures to determine the resource allocation schedule may facilitate efficient allocation of processing resources to the modeling procedures.

In some implementations, the resource allocation schedule may allocate a specified amount of processing resources for the execution of the modeling procedures. The allocable amount of processing resources may be specified in a processing resource budget, which may be provided by a user or obtained from another suitable source. The processing resource budget may impose limits on the processing resources to be used for executing the modeling procedures (e.g., the amount of time to be used, the number of processing nodes to be used, the cost incurred for using a data center or cloud-based processing resources, etc.). In some implementations, the processing resource budget may impose limits on the total processing resources to be used for the process of generating a predictive model for a specified prediction problem.

Returning to FIG. 12, at step 1240 of method 1200, the results of executing the selected modeling procedures in accordance with the resource allocation schedule may be received. These results may include one or more predictive models generated by the executed modeling procedures. In some implementations, the predictive models received at step 1240 are fitted to dataset(s) associated with the prediction problem, because the execution of the modeling procedures may include fitting of the predictive models to one or more datasets associated with the prediction problem. Fitting the predictive models to the prediction problem's dataset(s) may include tuning one or more hyper-parameters of the predictive modeling procedure that generates the predictive model, tuning one or more parameters of the generated predictive model, and/or other suitable model-fitting steps.

In some implementations, the results received at step 1240 include evaluations (e.g., scores) of the models' performances on the prediction problem. These evaluations may be obtained by testing the predictive models on test dataset(s) associated with the prediction problem. In some implementations, testing a predictive model includes cross-validating the model using different folds of training datasets associated with the prediction problem. In some implementations, the execution of the modeling procedures includes the testing of the generated models. In some implementations, the testing of the generated models is performed separately from the execution of the modeling procedures.

The models may be tested in accordance with suitable testing techniques and scored according to a suitable scoring metric (e.g., an objective function). Different scoring metrics may place different weights on different aspects of a predictive model's performance, including, without limitation, the model's accuracy (e.g., the rate at which the model correctly predicts the outcome of the prediction problem), false positive rate (e.g., the rate at which the model incorrectly predicts a “positive” outcome), false negative rate (e.g., the rate at which the model incorrectly predicts a “negative” outcome), positive prediction value, negative prediction value, sensitivity, specificity, etc. The user may select a standard scoring metric (e.g., goodness-of-fit, R-square, etc.) from a set of options presented via user interface 1020, or specific a custom scoring metric (e.g., a custom objective function) via user interface 1020. Exploration engine 1010 may use the user-selected or user-specified scoring metric to score the performance of the predictive models.

Returning to FIG. 12, at step 1250 of method 1200, a predictive model may be selected for the prediction problem based on the evaluations (e.g., scores) of the generated predictive models. Space search engine 1010 may use any suitable criteria to select the predictive model for the prediction problem. In some implementations, space search engine 1010 may select the model with the highest score, or any model having a score that exceeds a threshold score, or any model having a score within a specified range of the highest score. In some implementations, the predictive models' scores may be just one factor considered by space exploration engine 1010 in selecting a predictive model for the prediction problem. Other factors considered by space exploration engine may include, without limitation, the predictive model's complexity, the computational demands of the predictive model, etc.

In some implementations, selecting the predictive model for the prediction problem may comprise iteratively selecting a subset of the predictive models and training the selected predictive models on larger or different portions of the dataset. This iterative process may continue until a predictive model is selected for the prediction problem or until the processing resources budgeted for generating the predictive model are exhausted.

Selecting a subset of predictive models may comprise selecting a fraction of the predictive models with the highest scores, selecting all models having scores that exceed a threshold score, selecting all models having scores within a specified range of the score of the highest-scoring model, or selecting any other suitable group of models. In some implementations, selecting the subset of predictive models may be analogous to selecting a subset of predictive modeling procedures, as described above with reference to step 1220 of method 1200. Accordingly, the details of selecting a subset of predictive models are not belabored here.

Training the selected predictive models may comprise generating a resource allocation schedule that allocates processing resources of the processing nodes for the training of the selected models. The allocation of processing resources may be determined based, at least in part, on the suitability of the modeling techniques used to generate the selected models, and/or on the selected models' scores for other samples of the dataset. Training the selected predictive models may further comprise transmitting instructions to processing nodes to fit the selected predictive models to a specified portion of the dataset, and receiving results of the training process, including fitted models and/or scores of the fitted models. In some implementations, training the selected predictive models may be analogous to executing the selected predictive modeling procedures, as described above with reference to steps 1220-1240 of method 1200. Accordingly, the details of training the selected predictive models are not belabored here.

In some implementations, steps 1230 and 1240 may be performed iteratively until a predictive model is selected for the prediction problem or until the processing resources budgeted for generating the predictive model are exhausted. At the end of each iteration, the suitability of the predictive modeling procedures for the prediction problem may be re-determined based, at least in part, on the results of executing the modeling procedures, and a new set of predictive modeling procedures may be selected for execution during the next iteration.

In some implementations, the number of modeling procedures executed in an iteration of steps 1230 and 1240 may tend to decrease as the number of iterations increases, and the amount of data used for training and/or testing the generated models may tend to increase as the number of iterations increases. Thus, the earlier iterations may “cast a wide net” by executing a relatively large number of modeling procedures on relatively small datasets, and the later iterations may perform more rigorous testing of the most promising modeling procedures identified during the earlier iterations. Alternatively or in addition, the earlier iterations may implement a more coarse-grained evaluation of the search space, and the later iterations may implement more fine-grained evaluations of the portions of the search space determined to be most promising.

In some implementations, method 1200 includes one or more steps not illustrated in FIG. 12. Additional steps of method 1200 may include, without limitation, processing a dataset associated with the prediction problem, blending two or more predictive models to form a blended predictive model, and/or tuning the predictive model selected for the prediction problem. Some implementations of these steps are described in further detail below.

Method 1200 may include a step in which the dataset associated with a prediction problem is processed. In some implementations, processing a prediction problem's dataset includes characterizing the dataset. Characterizing the dataset may include identifying potential problems with the dataset, including but not limited to identifying data leaks (e.g., scenarios in which the dataset includes a feature that is strongly correlated with the target, but the value of the feature would not be available as input to the predictive model under the conditions imposed by the prediction problem), detecting missing observations, detecting missing variable values, identifying outlying variable values, and/or identifying variables that are likely to have significant predictive value (“predictive variables”).

In some implementations, processing a prediction problem's dataset includes applying feature engineering to the dataset. Applying feature engineering to the dataset may include combining two or more features and replacing the constituent features with the combined feature, extracting different aspects of date/time variables (e.g., temporal and seasonal information) into separate variables, normalizing variable values, infilling missing variable values, etc.

Method 1200 may include a step in which two or more predictive models are blended to form a blended predictive model. The blending step may be performed iteratively in connection with executing the predictive modeling techniques and evaluating the generated predictive models. In some implementations, the blending step may be performed in only some of the execution/evaluation iterations (e.g., in the later iterations, when multiple promising predictive models have been generated).

Two or more models may be blended by combining the outputs of the constituent models. In some implementations, the blended model may comprise a weighted, linear combination of the outputs of the constituent models. A blended predictive model may perform better than the constituent predictive models, particularly in cases where different constituent models are complementary. For example, a blended model may be expected to perform well when the constituent models tend to perform well on different portions of the prediction problem's dataset, when blends of the models have performed well on other (e.g., similar) prediction problems, when the modeling techniques used to generate the models are dissimilar (e.g., one model is a linear model and the other model is a tree model), etc. In some implementations, the constituent models to be blended together are identified by a user (e.g., based on the user's intuition and experience).

Method 1200 may include a step in which the predictive model selected for the prediction problem is tuned. In some cases, deployment engine 1040 provides the source code that implements the predictive model to the user, thereby enabling the user to tune the predictive model. However, disclosing a predictive model's source code may be undesirable in some cases (e.g., in cases where the predictive modeling technique or predictive model contains proprietary capabilities or information). To permit a user to tune a predictive model without exposing the model's source code, deployment engine 1040 may construct human-readable rules for tuning the model's parameters based on a representation (e.g., a mathematical representation) of the predictive model, and provide the human-readable rules to the user. The user can then use the human-readable rules to tune the model's parameters without accessing the model's source code. Thus, predictive modeling system 1000 may support evaluation and tuning of proprietary predictive modeling techniques without exposing the source code for the proprietary modeling techniques to end users.

In some implementations, the machine-executable templates corresponding to predictive modeling procedures may include efficiency-enhancing features to reduce redundant computation. These efficiency-enhancing features can be particularly valuable in cases where relatively small amounts of processing resources are budgeted for exploring the search space and generating the predictive model. As described above, the machine-executable templates may store unique IDs for the corresponding modeling elements (e.g., techniques, tasks, or sub-tasks). In addition, predictive modeling system 1000 may assign unique IDs to dataset samples S. In some implementations, when a machine-executable template T is executed on a dataset sample S, the template stores its modeling element ID, the dataset/sample ID, and the results of executing the template on the data sample in a storage structure (e.g., a table, a cache, a hash, etc.) accessible to the other templates. When a template T is invoked on a dataset sample S, the template checks the storage structure to determine whether the results of executing that template on that dataset sample are already stored. If so, rather than reprocessing the dataset sample to obtain the same results, the template simply retrieves the corresponding results from the storage structure, returns those results, and terminates. The storage structure may persist within individual iterations of the loop in which modeling procedures are executed, across multiple iterations of the procedure-execution loop, or across multiple search space explorations. The computational savings achieved through this efficiency-enhancing feature can be appreciable, since many tasks and sub-tasks are shared by different modeling techniques, and method 1200 often involves executing different modeling techniques on the same datasets.

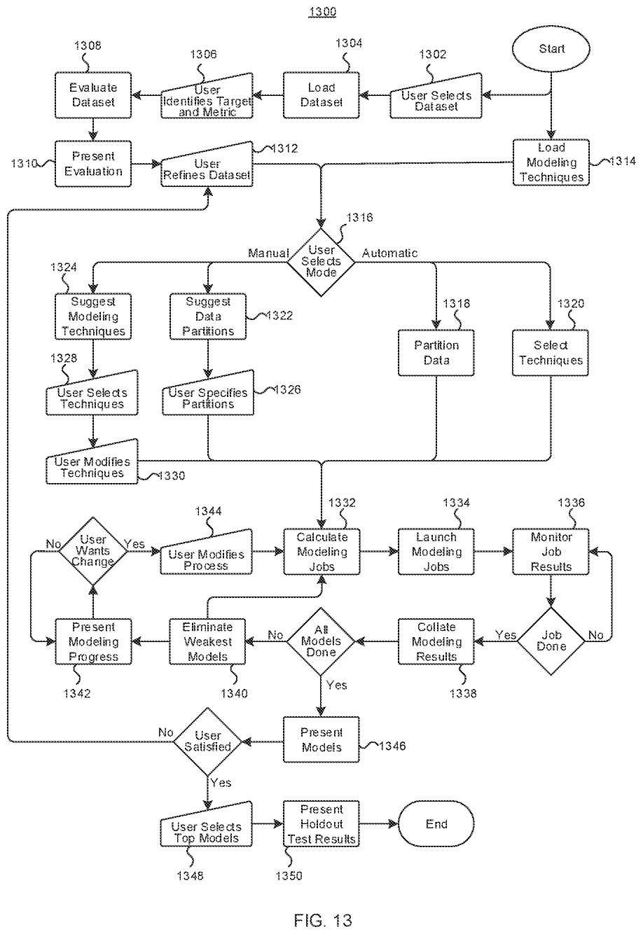

FIG. 13 shows a flowchart of a method 1300 for selecting a predictive model for a prediction problem, in accordance with some implementations. Method 1200 may be embodied by the example of method 1300.

In the example of FIG. 13, space search engine 1010 uses the modeling methodology library 1112, the modeling technique library 1030, and the modeling task library 1132 to search the space of available modeling techniques for a solution to a predictive modeling problem. Initially, the user may select a modeling methodology from library 1112, or space search engine 1010 may automatically select a default modeling methodology. The available modeling methodologies may include, without limitation, selection of modeling techniques based on application of deductive rules, selection of modeling techniques based on the performance of similar modeling techniques on similar prediction problems, selection of modeling techniques based on the output of a meta machine-learning model, any combination of the foregoing modeling techniques, or other suitable modeling techniques.

At step 1302 of method 1300, the exploration engine 1010 prompts the user to select the dataset for the predictive modeling problem to be solved. The user can chose from previously loaded datasets or create a new dataset, either from a file or instructions for retrieving data from other information systems. In the case of files, the exploration engine 1010 may support one or more formats including, without limitation, comma separated values, tab-delimited, eXtensible Markup Language (XML), JavaScript Object Notation, native database files, etc. In the case of instructions, the user may specify the types of information systems, their network addresses, access credentials, references to the subsets of data within each system, and the rules for mapping the target data schemas into the desired dataset schema. Such information systems may include, without limitation, databases, data warehouses, data integration services, distributed applications, Web services, etc.

At step 1304 of method 1300, exploration engine 1010 loads the data (e.g., by reading the specified file or accessing the specified information systems). Internally, the exploration engine 1010 may construct a two-dimensional matrix with the features on one axis and the observations on the other. Conceptually, each column of the matrix may correspond to a variable, and each row of the matrix may correspond to an observation. The exploration engine 1010 may attach relevant metadata to the variables, including metadata obtained from the original source (e.g., explicitly specified data types) and/or metadata generated during the loading process (e.g., the variable's apparent data types; whether the variables appear to be numerical, ordinal, cardinal, or interpreted types; etc.).

At step 1306 of method 1300, exploration engine 1010 prompts the user to identify which of the variables are targets and/or which are features. In some implementations, exploration engine 1010 also prompts the user to identify the metric of model performance to be used for scoring the models (e.g., the metric of model performance to be optimized, in the sense of statistical optimization techniques, by the statistical learning algorithm implemented by exploration engine 1010).

At step 1308 of method 1300, exploration engine 1010 evaluates the dataset. This evaluation may include calculating the characteristics of the dataset. In some implementations, this evaluation includes performing an analysis of the dataset, which may help the user better understand the prediction problem. Such an analysis may include applying one or more algorithms to identify problematic variables (e.g., those with outliers or inliers), determining variable importance, determining variable effects, and identifying effect hotspots.

The analysis of the dataset may be performed using any suitable techniques. Variable importance, which measures the degree of significance each feature has in predicting the target, may be analyzed using “gradient boosted trees”, Breiman and Cutler's “Random Forest”, “alternating conditional expectations”, and/or other suitable techniques. Variable effects, which measure the directions and sizes of the effects features have on a target, may be analyzed using “regularized regression”, “logistic regression”, and/or other suitable techniques. Effect hotspots, which identify the ranges over which features provide the most information in predicting the target, may be analyzed using the “RuleFit” algorithm and/or other suitable techniques.

In some implementations, in addition to assessing the importance of features contained in the original dataset, the evaluation performed at step 1308 of method 1300 includes feature generation. Feature generation techniques may include generating additional features by interpreting the logical type of the dataset's variable and applying various transformations to the variable. Examples of transformations include, without limitation, polynomial and logarithmic transformations for numeric features. For interpreted variables (e.g., date, time, currency, measurement units, percentages, and location coordinates), examples of transformations include, without limitation, parsing a date string into a continuous time variable, day of week, month, and season to test each aspect of the date for predictive power.

The systematic transformation of numeric and/or interpreted variables, followed by their systematic testing with potential predictive modeling techniques may enable predictive modeling system 1000 to search more of the potential model space and achieve more precise predictions. For example, in the case of “date/time”, separating temporal and seasonal information into separate features can be very beneficial because these separate features often exhibit very different relationships with the target variable.

Creating derived features by interpreting and transforming the original features can increase the dimensionality of the original dataset. The predictive modeling system 1000 may apply dimension reduction techniques, which may counter the increase in the dataset's dimensionality. However, some modeling techniques are more sensitive to dimensionality than others. Also, different dimension reduction techniques tend to work better with some modeling techniques than others. In some implementations, predictive modeling system 1000 maintains metadata describing these interactions. The system 1000 may systematically evaluate various combinations of dimension reduction techniques and modeling techniques, prioritizing the combinations that the metadata indicate are most likely to succeed. The system 1000 may further update this metadata based on the empirical performance of the combinations over time and incorporate new dimension reduction techniques as they are discovered.

At step 1310 of method 1300, predictive modeling system 1000 presents the results of the dataset evaluation (e.g., the results of the dataset analysis, the characteristics of the dataset, and/or the results of the dataset transformations) to the user. In some implementations, the results of the dataset evaluation are presented via user interface 1020 (e.g., using graphs and/or tables).

At step 1312 of method 1300, the user may refine the dataset (e.g., based on the results of the dataset evaluation). Such refinement may include selecting methods for handling missing values or outliers for one or more features, changing an interpreted variable's type, altering the transformations under consideration, eliminating features from consideration, directly editing particular values, transforming features using a function, combining the values of features using a formula, adding entirely new features to the dataset, etc.

Steps 1302-1312 of method 1300 may represent one implementation of the step of processing a prediction problem's dataset, as described above in connection with some implementations of method 1200.

At step 1314 of method 1300, the exploration engine 1010 may load the available modeling techniques from the modeling technique library 1030. The determination of which modeling techniques are available may depend on the selected modeling methodology. In some implementations, the loading of the modeling techniques may occur in parallel with one or more of steps 1302-1312 of method 1300.

At step 1316 of method 1300, the user instructs the exploration engine 1010 to begin the search for modeling solutions in either manual mode or automatic mode. In automatic mode, the exploration engine 1010 partitions the dataset (step 1318) using a default sampling algorithm and prioritizes the modeling techniques (step 1320) using a default prioritization algorithm. Prioritizing the modeling techniques may include determining the suitability of the modeling techniques for the prediction problem, and selecting at least a subset of the modeling techniques for execution based on their determined suitability.

In manual mode, the exploration engine 1010 suggests data partitions (step 1322) and suggests a prioritization of the modeling techniques (step 1324). The user may accept the suggested data partition or specify custom partitions (step 1326). Likewise, the user may accept the suggested prioritization of modeling techniques or specify a custom prioritization of the modeling techniques (step 1328). In some implementations, the user can modify one or more modeling techniques (e.g., using the modeling technique builder 1120 and/or the modeling task builder 1130) (step 1330) before the exploration engine 1010 begins executing the modeling techniques.

To facilitate cross-validation, predictive modeling system 1000 may partition the dataset (or suggest a partitioning of the dataset) into K “folds”. Cross-validation comprises fitting a predictive model to the partitioned dataset K times, such that during each fitting, a different fold serves as the test set and the remaining folds serve as the training set. Cross-validation can generate useful information about how the accuracy of a predictive model varies with different training data. In steps 1318 and 1322, predictive modeling system may partition the dataset into K folds, where the number of folds K is a default parameter. In step 1326, the user may change the number of folds K or cancel the use of cross-validation altogether.

To facilitate rigorous testing of the predictive models, predictive modeling system 1000 may partition the dataset (or suggest a partitioning of the dataset) into a training set and a “holdout” test set. In some implementations, the training set is further partitioned into K folds for cross-validation. The training set may then be used to train and evaluate the predictive models, but the holdout test set may be reserved strictly for testing the predictive models. In some implementations, predictive modeling system 1000 can strongly enforce the use of the holdout test set for testing (and not for training) by making the holdout test set inaccessible until a user with the designated authority and/or credentials releases it. In steps 1318 and 1322, predictive modeling system 1000 may partition the dataset such that a default percentage of the dataset is reserved for the holdout set. In step 1326, the user may change the percentage of the dataset reserved for the holdout set, or cancel the use of a holdout set altogether.

In some implementations, predictive modeling system 1000 partitions the dataset to facilitate efficient use of computing resources during the evaluation of the modeling search space. For example, predictive modeling system 1000 may partition the cross-validation folds of the dataset into smaller samples. Reducing the size of the data samples to which the predictive models are fitted may reduce the amount of computing resources needed to evaluate the relative performance of different modeling techniques. In some implementations, the smaller samples may be generated by taking random samples of a fold's data. Likewise, reducing the size of the data samples to which the predictive models are fitted may reduce the amount of computing resources needed to tune the parameters of a predictive model or the hyper-parameters of a modeling technique. Hyper-parameters include variable settings for a modeling technique that can affect the speed, efficiency, and/or accuracy of model fitting process. Examples of hyper-parameters include, without limitation, the penalty parameters of an elastic-net model, the number of trees in a gradient boosted trees model, the number of neighbors in a nearest neighbors model, etc.

In steps 1332-458 of method 1300, the selected modeling techniques may be executed using the partitioned data to evaluate the search space. These steps are described in further detail below. For convenience, some aspects of the evaluation of the search space relating to data partitioning are described in the following paragraphs.

Tuning hyper-parameters using sample data that includes the test set of a cross-validation fold can lead to model over-fitting, thereby making comparisons of different models' performance unreliable. Using a “specified approach” can help avoid this problem, and can provide several other advantages. Some implementations of exploration engine 1010 therefore implement “nested cross-validation”, a technique whereby two loops of k-fold cross validation are applied. The outer loop provides a test set for both comparing a given model to other models and calibrating each model's predictions on future samples. The inner loop provides both a test set for tuning the hyper-parameters of the given model and a training set for derived features.

Moreover, the cross-validation predictions produced in the inner loop may facilitate blending techniques that combine multiple different models. In some implementations, the inputs into a blender are predictions from an out-of-sample model. Using predictions from an in-sample model could result in over-fitting if used with some blending algorithms. Without a well-defined process for consistently applying nested cross-validation, even the most experienced users can omit steps or implement them incorrectly. Thus, the application of a double loop of k-fold cross validation may allow predictive modeling system 1000 to simultaneously achieve five goals: (1) tuning complex models with many hyper-parameters, (2) developing informative derived features, (3) tuning a blend of two or more models, (4) calibrating the predictions of single and/or blended models, and (5) maintaining a pure untouched test set that allows an accurate comparison of different models.

At step 1332 of method 1300, the exploration engine 1010 generates a resource allocation schedule for the execution of an initial set of the selected modeling techniques. The allocation of resources represented by the resource allocation schedule may be determined based on the prioritization of modeling techniques, the partitioned data samples, and the available computation resources. In some implementations, exploration engine 1010 allocates resources to the selected modeling techniques greedily (e.g., assigning computational resources in turn to the highest-priority modeling technique that has not yet executed).

At step 1334 of method 1300, the exploration engine 1010 initiates execution of the modeling techniques in accordance with the resource allocation schedule. In some implementations, execution of a set of modeling techniques may comprise training one or more models on a same data sample extracted from the dataset.

At step 1336 of method 1300, the exploration engine 1010 monitors the status of execution of the modeling techniques. When a modeling technique is finished executing, the exploration engine 1010 collects the results (step 1338), which may include the fitted model and/or metrics of model fit for the corresponding data sample. Such metrics may include any metric that can be extracted from the underlying software components that perform the fitting, including, without limitation, Gini coefficient, r-squared, residual mean squared error, any variations thereof, etc.

At step 1340 of method 1300, the exploration engine 1010 eliminates the worst-performing modeling techniques from consideration (e.g., based on the performance of the models they produced according to model fit metrics). Exploration engine 1010 may determine which modeling techniques to eliminate using a suitable technique, including, without limitation, eliminating those that do not produce models that meet a minimum threshold value of a model fit metric, eliminating all modeling techniques except those that have produced models currently in the top fraction of all models produced, or eliminating any modeling techniques that have not produced models that are within a certain range of the top models. In some implementations, different procedures may be used to eliminate modeling techniques at different stages of the evaluation. In some implementations, users may be permitted to specify different elimination-techniques for different modeling problems. In some implementations, users may be permitted to build and use custom elimination techniques. In some implementations, meta-statistical-learning techniques may be used to choose among elimination-techniques and/or to adjust the parameters of those techniques.

As the exploration engine 1010 calculates model performance and eliminates modeling techniques from consideration, predictive modeling system 1000 may present the progress of the search space evaluation to the user through the user interface 1020 (step 1342). In some implementations, at step 1344, exploration engine 1010 permits the user to modify the process of evaluating the search space based on the progress of the search space evaluation, the user's expert knowledge, and/or other suitable information. If the user specifies a modification to the search space evaluation process, the space evaluation engine 1010 reallocates processing resources accordingly (e.g., determines which jobs are affected and either moves them within the scheduling queue or deletes them from the queue). Other jobs continue processing as before.

The user may modify the search space evaluation process in many different ways. For example, the user may reduce the priority of some modeling techniques or eliminate some modeling techniques from consideration altogether even though the performance of the models they produced on the selected metric was good. As another example, the user may increase the priority of some modeling techniques or select some modeling techniques for consideration even though the performance of the models they produced was poor. As another example, the user may prioritize evaluation of specified models or execution of specified modeling techniques against additional data samples. As another example, a user may modify one or more modeling techniques and select the modified techniques for consideration. As another example, a user may change the features used to train the modeling techniques or fit the models (e.g., by adding features, removing features, or selecting different features). Such a change may be beneficial if the results indicate that the feature magnitudes require normalizations or that some of the features are “data leaks”.

In some implementations, steps 1332-1344 may be performed iteratively. Modeling techniques that are not eliminated (e.g., by the system at step 1340 or by the user at step 1344) survive another iteration. Based on the performance of a model generated in the previous iteration (or iterations), the exploration engine 1010 adjusts the corresponding modeling technique's priority and allocates processing resources to the modeling technique accordingly. As computational resources become available, the engine uses the available resources to launch model-technique-execution jobs based on the updated priorities.

In some implementations, at step 1332, exploration engine 1010 may “blend” multiple models using different mathematical combinations to create new models (e.g., using stepwise selection of models to include in the blender). In some implementations, predictive modeling system 1000 provides a modular framework that allows users to plug in their own automatic blending techniques. In some implementations, predictive modeling system 1000 allows users to manually specify different model blends.

In some implementations, predictive modeling system 1000 may offer one or more advantages in developing blended prediction models. First, blending may work better when a large variety of candidate models are available to blend. Moreover, blending may work better when the differences between candidate models correspond not simply to minor variations in algorithms but rather to major differences in approach, such as those among linear models, tree-based models, support vector machines, and nearest neighbor classification. Predictive modeling system 1000 may deliver a substantial head start by automatically producing a wide variety of models and maintaining metadata describing how the candidate models differ. Predictive modeling system 1000 may also provide a framework that allows any model to be incorporated into a blended model by, for example, automatically normalizing the scale of variables across the candidate models. This framework may allow users to easily add their own customized or independently generated models to the automatically generated models to further increase variety.

In addition to increasing the variety of candidate models available for blending, the predictive modeling system 1000 also provides a number of user interface features and analytic features that may result in superior blending. First, user interface 1020 may provide an interactive model comparison, including several different alternative measures of candidate model fit and graphics such as dual lift charts, so that users can easily identify accurate and complementary models to blend. Second, modeling system 1000 gives the user the option of choosing specific candidate models and blending techniques or automatically fitting some or all of the blending techniques in the modeling technique library using some or all of the candidate models. The nested cross-validation framework then enforces the condition that the data used to rank each blended model is not used in tuning the blender itself or in tuning its component models' hyper-parameters. This discipline may provide the user a more accurate comparison of alternative blender performance. In some implementations, modeling system 1000 implements a blended model's processing in parallel, such that the computation time for the blended model approaches the computation time of its slowest component model.

Returning to FIG. 13, at step 1346 of method 1300, the user interface 1020 presents the final results to the user. Based on this presentation, the user may refine the dataset (e.g., by returning to step 1312), adjust the allocation of resources to executing modeling techniques (e.g., by returning to step 1344), modify one or more of the modeling techniques to improve accuracy (e.g., by returning to step 1330), alter the dataset (e.g., by returning to step 1302), etc.

At step 1348 of method 1300, rather than restarting the search space evaluation or a portion thereof, the user may select one or more top predictive model candidates. At step 1350, predictive modeling system 1000 may present the results of the holdout test for the selected predictive model candidate(s). The holdout test results may provide a final gauge of how these candidates compare. In some implementations, only users with adequate privileges may release the holdout test results. Preventing the release of the holdout test results until the candidate predictive models are selected may facilitate an unbiased evaluation of performance. However, the exploration engine 1010 may actually calculate the holdout test results during the modeling job execution process (e.g., steps 1332-1344), as long as the results remain hidden until after the candidate predictive models are selected.

Returning to FIG. 10, the user interface 1020 may provide tools for monitoring and/or guiding the search of the predictive modeling space. These tools may provide insight into a prediction problem's dataset (e.g., by highlighting problematic variables in the dataset, identifying relationships between variables in the dataset, etc.), and/or insights into the results of the search. In some implementations, data analysts may use the interface to guide the search, e.g., by specifying the metrics to be used to evaluate and compare modeling solutions, by specifying the criteria for recognizing a suitable modeling solution, etc. Thus, the user interface may be used by analysts to improve their own productivity, and/or to improve the performance of the exploration engine 1010. In some implementations, user interface 1020 presents the results of the search in real-time, and permits users to guide the search (e.g., to adjust the scope of the search or the allocation of resources among the evaluations of different modeling solutions) in real-time. In some implementations, user interface 1020 provides tools for coordinating the efforts of multiple data analysts working on the same prediction problem and/or related prediction problems.

In some implementations, the user interface 1020 provides tools for developing machine-executable templates for the library 1030 of modeling techniques. System users may use these tools to modify existing templates, to create new templates, or to remove templates from the library 1030. In this way, system users may update the library 1030 to reflect advances in predictive modeling research, and/or to include proprietary predictive modeling techniques.

User interface 1020 may include a variety of interface components that allow users to manage multiple modeling projects within an organization, create and modify elements of the modeling methodology hierarchy, conduct comprehensive searches for accurate predictive models, gain insights into the dataset and model results, and/or deploy completed models to produce predictions on new data.

In some implementations, the user interface 1020 distinguishes between four types of users: administrators, technique developers, model builders, and observers. Administrators may control the allocation of human and computing resources to projects. Technique developers may create and modify modeling techniques and their component tasks. Model builders primarily focus on searching for good models, though they may also make minor adjustments to techniques and tasks. Observers may view certain aspects of project progress and modelling results, but may be prohibited from making any changes to data or initiating any model-building. An individual may fulfill more than one role on a specific project or across multiple projects.

Users acting as administrators may access the project management components of user interface 1020 to set project parameters, assign project responsibilities to users, and allocate computing resources to projects. In some implementations, administrators may use the project management components to organize multiple projects into groups or hierarchies. All projects within a group may inherit the group's settings. In a hierarchy, all children of a project may inherit the project's settings. In some implementations, users with sufficient permissions may override inherited settings. In some implementations, users with sufficient permissions may further divide settings into different sections so that only users with the corresponding permissions may alter them. In some cases, administrators may permit access to certain resources orthogonally to the organization of projects. For example, certain techniques and tasks may be made available to every project unless explicitly prohibited. Others may be prohibited to every project unless explicitly allowed. Moreover, some resources may be allocated on a user basis, so that a project can only access the resources if a user who possesses those rights is assigned to that particular project.

In managing users, administrators may control the group of all users admitted to the system, their permitted roles, and system-level permissions. In some implementations, administrators may add users to the system by adding them to a corresponding group and issuing them some form of access credentials. In some implementations, user interface 1020 may support different kinds of credentials including, without limitation, username plus password, unified authorization frameworks (e.g., OAuth), hardware tokens (e.g., smart cards), etc.

Once admitted, an administrator may specify that certain users have default roles that they assume for any project. For example, a particular user may be designated as an observer unless specifically authorized for another role by an administrator for a particular project. Another user may be provisioned as a technique developer for all projects unless specifically excluded by an administrator, while another may be provisioned as a technique developer for only a particular group of projects or branch of the project hierarchy. In addition to default roles, administrators may further assign users more specific permissions at the system level. For example, some Administrators may be able to grant access to certain types of computing resources, some technique developers and model builders may be able to access certain features within the builders; and some model builders may be authorized to start new projects, consume more than a given level of computation resources, or invite new users to projects that they do not own.

In some implementations, administrators may assign access, permissions, and responsibilities at the project level. Access may include the ability to access any information within a particular project. Permissions may include the ability to perform specific operations for a project. Access and permissions may override system-level permissions or provide more granular control. As an example of the former, a user who normally has full builder permissions may be restricted to partial builder permissions for a particular project. As an example of the latter, certain users may be limited from loading new data to an existing project. Responsibilities may include action items that a user is expected to complete for the project.

Users acting as developers may access the builder areas of the interface to create and modify modeling methodologies, techniques, and tasks. As discussed previously, each builder may present one or more tools with different types of user interfaces that perform the corresponding logical operations. In some implementations, the user interface 1020 may permit developers to use a “Properties” sheet to edit the metadata attached to a technique. A technique may also have tuning parameters corresponding to variables for particular tasks. A developer may publish these tuning parameters to the technique-level Properties sheet, specifying default values and whether or not model builders may override these defaults.

In some implementations, the user interface 1020 may offer a graphical flow-diagram tool for specifying a hierarchical directed graph of tasks, along with any built-in operations for conditional logic, filtering output, transforming output, partitioning output, combining inputs, iterating over sub-graphs, etc. In some implementations, user interface 1020 may provide facilities for creating the wrappers around pre-existing software to implement leaf-level tasks, including properties that can be set for each task.

In some implementations, user interface 1020 may provide advanced developers built-in access to interactive development environments (IDEs) for implementing leaf-level tasks. While developers may, alternatively, code a component in an external environment and wrap that code as a leaf-level task, it may be more convenient if these environments are directly accessible. In such an implementation, the IDEs themselves may be wrapped in the interface and logically integrated into the task builder. From the user perspective, an IDE may run within the same interface framework and on the same computational infrastructure as the task builder. This capability may enable advanced developers to more quickly iterate in developing and modifying techniques. Some implementations may further provide code collaboration features that facilitate coordination between multiple developers simultaneously programming the same leaf-level tasks.

Model builders may leverage the techniques produced by developers to build predictive models for their specific datasets. Different model builders may have different levels of experience and thus require different support from the user interface. For relatively new users, the user interface 1020 may present as automatic a process as possible, but still give users the ability to explore options and thereby learn more about predictive modeling. For intermediate users, the user interface 1020 may present information to facilitate rapidly assessing how easy a particular problem will be to solve, comparing how their existing predictive models stack up to what the predictive modeling system 1000 can produce automatically, and getting an accelerated start on complicated projects that will eventually benefit from substantial hands-on tuning. For advanced users, the user interface 1020 may facilitate extraction of a few extra decimal places of accuracy for an existing predictive model, rapid assessment of applicability of new techniques to the problems they've worked on, and development of techniques for a whole class of problems their organizations may face. By capturing the knowledge of advanced users, some implementations facilitate the propagation of that knowledge throughout the rest of the organization.

To support this breadth of user requirements, some implementations of user interface 1020 provide a sequence of interface tools that reflect the model building process. Moreover, each tool may offer a spectrum of features from basic to advanced. The first step in the model building process may involve loading and preparing a dataset. As discussed previously, a user may upload a file or specify how to access data from an online system. In the context of modeling project groups or hierarchies, a user may also specify what parts of the parent dataset are to be used for the current project and what parts are to be added.

For basic users, predictive modeling system 1000 may immediately proceed to building models after the dataset is specified, pausing only if the use interface 1020 flags troubling issues, including, without limitation, unparseable data, too few observations to expect good results, too many observations to execute in a reasonable amount time, too many missing values, or variables whose distributions may lead to unusual results. For intermediate users, user interface 1020 may facilitate understanding the data in more depth by presenting the table of data set characteristics and the graphs of variable importance, variable effects, and effect hotspots. User interface 1020 may also facilitate understanding and visualization of relationships between the variables by providing visualization tools including, without limitation, correlation matrixes, partial dependence plots, and/or the results of unsupervised machine-learning algorithms such as k-means and hierarchical clustering. In some implementations, user interface 1020 permits advanced users to create entirely new dataset features by specifying formulas that transform an existing feature or combination of them.

Once the dataset is loaded, users may specify the model-fit metric to be optimized. For basic users, predictive modeling system 1000 may choose the model-fit metric, and user interface 1020 may present an explanation of the choice. For intermediate users, user interface 1020 may present information to help the users understand the tradeoffs in choosing different metrics for a particular dataset. For advanced users, user interface 1020 may permit the user to specify custom metrics by writing formulas (e.g., objective functions) based on the low-level performance data collected by the exploration engine 1010 or even by uploading custom metric calculation code.

With the dataset loaded and model-fit metric selected, the user may launch the exploration engine. For basic users, the exploration engine 1010 may use the default prioritization settings for modeling techniques, and user interface 1020 may provide high-level information about model performance, how far into the dataset the execution has progressed, and the general consumption of computing resources. For intermediate users, user interface 1020 may permit the user to specify a subset of techniques to consider and slightly adjust some of the initial priorities. In some implementations, user interface 1020 provides more granular performance and progress data so intermediate users can make in-flight adjustments as previously described. In some implementations, user interface 1020 provides intermediate users with more insight into and control of computing resource consumption. In some implementations, user interface 1020 may provide advanced users with significant (e.g., complete) control of the techniques considered and their priority, all the performance data available, and significant (e.g., complete) control of resource consumption. By either offering distinct interfaces to different levels of users or “collapsing” more advanced features for less advanced users by default, some implementations of user interface 1020 can support the users at their corresponding levels.

During and after the exploration of the search space, the user interface may present information about the performance of one or more modeling techniques. Some performance information may be displayed in a tabular format, while other performance information may be displayed in a graphical format. For example, information presented in tabular format may include, without limitation, comparisons of model performance by technique, fraction of data evaluated, technique properties, or the current consumption of computing resources. Information presented in graphical format may include, without limitation, the directed graph of tasks in a modeling procedure, comparisons of model performance across different partitions of the dataset, representations of model performance such as the receiver operating characteristics and lift chart, predicted vs. actual values, and the consumption of computing resources over time. The user interface 1020 may include a modular user interface framework that allows for the easy inclusion of new performance information of either type. Moreover, some implementations may allow the display of some types of information for each data partition and/or for each technique.

As discussed previously, some implementations of user interface 1020 support collaboration of multiple users on multiple projects. Across projects, user interface 1020 may permit users to share data, modeling tasks, and modeling techniques. Within a project, user interface 1020 may permit users to share data, models, and results. In some implementations, user interface 1020 may permit users to modify properties of the project and use resources allocated to the project. In some implementations, user interface 1020 may permit multiple users to modify project data and add models to the project, then compare these contributions. In some implementations, user interface 1020 may identify which user made a specific change to the project, when the change was made, and what project resources a user has used.

The model deployment engine 1040 provides tools for deploying predictive models in operational environments. In some implementations, the model deployment engine 1040 monitors the performance of deployed predictive models, and updates the performance metadata associated with the modeling techniques that generated the deployed models, so that the performance data accurately reflects the performance of the deployed models.

Users may deploy a fitted prediction model when they believe the fitted model warrants field testing or is capable of adding value. In some implementations, users and external systems may access a prediction module (e.g., in an interface services layer of predictive modeling system 1000), specify one or more predictive models to be used, and supply new observations. The prediction module may then return the predictions provided by those models. In some implementations, administrators may control which users and external systems have access to this prediction module, and/or set usage restrictions such as the number of predictions allowed per unit time.

For each model, exploration engine 1010 may store a record of the modeling technique used to generate the model and the state of model the after fitting, including coefficient and hyper-parameter values. Because each technique is already machine-executable, these values may be sufficient for the execution engine to generate predictions on new observation data. In some implementations, a model's prediction may be generated by applying the pre-processing and modeling steps described in the modeling technique to each instance of new input data. However, in some cases, it may be possible to increase the speed of future prediction calculations. For example, a fitted model may make several independent checks of a particular variable's value. Combining some or all of these checks and then simply referencing them when convenient may decrease the total amount of computation used to generate a prediction. Similarly, several component models of a blended model may perform the same data transformation. Some implementations may therefore reduce computation time by identifying duplicative calculations, performing them only once, and referencing the results of the calculations in the component models that use them.

In some implementations, deployment engine 1040 improves the performance of a prediction model by identifying opportunities for parallel processing, thereby decreasing the response time in making each prediction when the underlying hardware can execute multiple instructions in parallel. Some modeling techniques may describe a series of steps sequentially, but in fact some of the steps may be logically independent. By examining the data flow among each step, the deployment engine 1040 may identify situations of logical independence and then restructure the execution of predictive models so independent steps are executed in parallel. Blended models may present a special class of parallelization, because the constituent predictive models may be executed in parallel, once any common data transformations have completed.

In some implementations, deployment engine 1040 may cache the state of a predictive model in memory. With this approach, successive prediction requests of the same model may not incur the time to load the model state. Caching may work especially well in cases where there are many requests for predictions on a relatively small number of observations and therefore this loading time is potentially a large part of the total execution time.

In some implementations, deployment engine 1040 may offer at least two implementations of predictive models: service-based and code-based. For service-based prediction, calculations run within a distributed computing infrastructure as described below. Final prediction models may be stored in the data services layer of the distributed computing infrastructure. When a user or external system requests a prediction, it may indicate which model is to be used and provides at least one new observation. A prediction module may then load the model from the data services layer or from the module's in-memory cache, validate that the submitted observations matches the structure of the original dataset, and compute the predicted value for each observation. In some implementations, the predictive models may execute on a dedicated pool of cloud workers, thereby facilitating the generation of predictions with low-variance response times.

Service-based prediction may occur either interactively or via API. For interactive predictions, the user may enter the values of features for each new observation or upload a file containing the data for one or more observations. The user may then receive the predictions directly through the user interface 1020, or download them as a file. For API predictions, an external system may access the prediction module via local or remote API, submit one or more observations, and receive the corresponding calculated predictions in return.

Some implementations of deployment engine 1040 may allow an organization to create one or more miniaturized instances of the distributed computing infrastructure for the purpose of performing service-based prediction. In the distributed computing infrastructure's interface layer, each such instance may use the parts of the monitoring and prediction modules accessible by external systems, without accessing the user-related functions. The analytic services layer may not use the technique IDE module, and the rest of the modules in this layer may be stripped down and optimized for servicing prediction requests. The data services layer may not use the user or model-building data management. Such standalone prediction instances may be deployed on a parallel pool of cloud resources, distributed to other physical locations, or even downloaded to one or more dedicated machines that act as “prediction appliances”.

To create a dedicated prediction instance, a user may specify the target computing infrastructure, for example, whether it's a set of cloud instances or a set of dedicated hardware. The corresponding modules may then be provisioned and either installed on the target computing infrastructure or packaged for installation. The user may either configure the instance with an initial set of predictive models or create a “blank” instance. After initial installation, users may manage the available predictive models by installing new ones or updating existing ones from the main installation.

For code-based predictions, the deployment engine 1040 may generate source code for calculating predictions based on a particular model, and the user may incorporate the source code into other software. When models are based on techniques whose leaf-level tasks are all implemented in the same programming language as that requested by the user, deployment engine 1040 may produce the source code for the predictive model by collating the code for leaf-level tasks. When the model incorporates code from different languages or the language is different from that desired by the user, deployment engine 1040 may use more sophisticated approaches.

One approach is to use a source-to-source compiler to translate the source code of the leaf-level tasks into a target language. Another approach is to generate a function stub in the target language that then calls linked-in object code in the original language or accesses an emulator running such object code. The former approach may involve the use of a cross-compiler to generate object code specifically for the user's target computing platform. The latter approach may involve the use of an emulator that will run on the user's target platform.

Another approach is to generate an abstract description of a particular model and then compile that description into the target language. To generate an abstract description, some implementations of deployment engine 1040 may use meta-models for describing a large number of potential pre-processing, model-fitting, and post-processing steps. The deployment engine may then extract the particular operations for a complete model and encode them using the meta-model. In such implementations, a compiler for the target programming language may be used to translate the meta-models into the target language. So if a user wants prediction code in a supported language, the compiler may produce it. For example, in a decision-tree model, the decisions in the tree may be abstracted into logical if/then/else statements that are directly implementable in a wide variety of programming languages. Similarly, a set of mathematical operations that are supported in common programming languages may be used to implement a linear regression model.

However, disclosing a predictive model's source code in any language may be undesirable in some cases (e.g., in cases where the predictive modeling technique or predictive model contains proprietary capabilities or information). Therefore, the deployment engine 1040 may convert a predictive model into a set of rules that preserves the predictive capabilities of the predictive model without disclosing its procedural details. One approach is to apply an algorithm that produces such rules from a set of hypothetical predictions that a predictive model would generate in response to hypothetical observations. Some such algorithms may produce a set of if-then rules for making predictions. For these algorithms, the deployment engine 1040 may then convert the resulting if-then rules into a target language instead of converting the original predictive model. An additional advantage of converting a predictive model to a set of if-then rules is that it is generally easier to convert a set of if-then rules into a target programming language than a predictive model with arbitrary control and data flows because the basic model of conditional logic is more similar across programming languages.

Once a model starts making predictions on new observations, the deployment engine 1040 may track these predictions, measure their accuracy, and use these results to improve predictive modeling system 1000. In the case of service-based predictions, because predictions occur within the same distributed computing environment as the rest of the system, each observation and prediction may be saved via the data services layer. By providing an identifier for each prediction, some implementations may allow a user or external software system to submit the actual values, if and when they are recorded. In the case of code-based predictions, some implementations may include code that saves observations and predictions in a local system or back to an instance of the data services layer. Again, providing an identifier for each prediction may facilitate the collection of model performance data against the actual target values when they become available.

Information collected directly by the deployment engine 1040 about the accuracy of predictions, and/or observations obtained through other channels, may be used to improve the model for a prediction problem (e.g., to “refresh” an existing model, or to generate a model by re-exploring the modeling search space in part or in full). New data can be added to improve a model in the same ways data was originally added to create the model, or by submitting target values for data previously used in prediction.

Some models may be refreshed (e.g., refitted) by applying the corresponding modeling techniques to the new data and combining the resulting new model with the existing model, while others may be refreshed by applying the corresponding modeling techniques to a combination of original and new data. In some implementations, when refreshing a model, only some of the model parameters may be recalculated (e.g., to refresh the model more quickly, or because the new data provides information that is particularly relevant to particular parameters).

Alternatively or in addition, new models may be generated exploring the modeling search space, in part or in full, with the new data included in the dataset. The re-exploration of the search space may be limited to a portion of the search space (e.g., limited to modeling techniques that performed well in the original search), or may cover the entire search space. In either case, the initial suitability scores for the modeling technique(s) that generated the deployed model(s) may be recalculated to reflect the performance of the deployed model(s) on the prediction problem. Users may choose to exclude some of the previous data to perform the recalculation. Some implementations of deployment engine 1040 may track different versions of the same logical model, including which subsets of data were used to train which versions.

In some implementations, this prediction data may be used to perform post-request analysis of trends in input parameters or predictions themselves over time, and to alert the user of potential issues with inputs or the quality of the model predictions. For example, if an aggregate measure of model performance starts to degrade over time, the system may alert the user to consider refreshing the model or investigating whether the inputs themselves are shifting. Such shifts may be caused by temporal change in a particular variable or drifts in the entire population. In some implementations, most of this analysis is performed after prediction requests are completed, to avoid slowing down the prediction responses. However, the system may perform some validation at prediction time to avoid particularly bad predictions (e.g., in cases where an input value is outside a range of values that it has computed as valid given characteristics of the original training data, modeling technique, and final model fitting state).

After-the-fact analysis may be done in cases where a user has deployed a model to make extrapolations well beyond the population used in training. For example, a model may have been trained on data from one geographic region, but used to make predictions for a population in a completely different geographic region. Sometimes, such extrapolation to new populations may result in model performance that is substantially worse than expected. In these cases, the deployment engine 1040 may alert the user and/or automatically refresh the model by re-fitting one or more modeling techniques using the new values to extend the original training data.

The predictive modeling system 1000 may significantly improve the productivity of analysts at any skill level and/or significantly increase the accuracy of predictive models achievable with a given amount of resources. Automating procedures can reduce workload and systematizing processes can enforce consistency, enabling analysts to spend more time generating unique insights. Three common scenarios illustrate these advantages: forecasting outcomes, predicting properties, and inferring measurements.

Forecasting Outcomes

If an organization can accurately forecast outcomes, then it can both plan more effectively and enhance its behavior. Therefore, a common application of machine learning is to develop algorithms that produce forecasts. For example, many industries face the problem of predicting costs in large-scale, time-consuming projects.

In some implementations, the techniques described herein can be used for forecasting cost overruns (e.g., software cost overruns or construction cost overruns). For example, the techniques described herein may be applied to the problem of forecasting cost overruns as follows. This technical solution is not limited to the order of operations as discussed herein.

1. Select a model fitting metric appropriate to the response variable type (e.g., numerical or binary, approximately Gaussian or strongly non-Gaussian): Predictive modeling system 1000 may recommend a metric based on data characteristics, requiring less skill and effort by the user, but allows the user to make the final selection.

2. Pre-treat the data to address outliers and missing data values: Predictive modeling system 1000 may provide detailed summary of data characteristics, enabling users to develop better situational awareness of the modeling problem and assess potential modeling challenges more effectively. Predictive modeling system 1000 may include automated procedures for outlier detection and replacement, missing value imputation, and the detection and treatment of other data anomalies, requiring less skill and effort by the user. The predictive modeling system's procedures for addressing these challenges may be systematic, leading to more consistent modeling results across methods, datasets, and time than ad hoc data editing procedures.

3. Partition the data for modeling and evaluation: The predictive modeling system 1000 may automatically partition data into training, validation, and holdout sets. This partitioning may be more flexible than the train and test partitioning used by some data analysts, and consistent with widely accepted recommendations from the machine learning community. The use of a consistent partitioning approach across methods, datasets, and time can make results more comparable, enabling more effective allocation of deployment resources in commercial contexts.

4. Select model structures, generate derived features, select model tuning parameters, fit models, and evaluate: In some implementations, the predictive modeling system 1000 can fit many different model types, including, without limitation, decision trees, neural networks, support vector machine models, regression models, boosted trees, random forests, deep learning neural networks, etc. The predictive modeling system 1000 may provide the option of automatically constructing ensembles from those component models that exhibit the best individual performance. Exploring a larger space of potential models can improve accuracy. The predictive modeling system may automatically generate a variety of derived features appropriate to different data types (e.g., Box-Cox transformations, text pre-processing, principal components, etc.). Exploring a larger space of potential transformation can improve accuracy. The predictive modeling system 1000 may use cross validation to select the best values for these tuning parameters as part of the model building process, thereby improving the choice of tuning parameters and creating an audit trail of how the selection of parameters affects the results. The predictive modeling system 1000 may fit and evaluate the different model structures considered as part of this automated process, ranking the results in terms of validation set performance.

5. Select the final model: The choice of the final model can be made by the predictive modeling system 1000 or by the user. In the latter case, the predictive modeling system may provide support to help the user make this decision, including, for example, the ranked validation set performance assessments for the models, the option of comparing and ranking performance by other quality measures than the one used in the fitting process, and/or the opportunity to build ensemble models from those component models that exhibit the best individual performance.

A practical aspect of the predictive modeling system's model development process is that, once the initial dataset has been assembled, all subsequent computations may occur within the same software environment. This aspect represents a difference from the conventional model-building efforts, which often involves a combination of different software environments. A practical disadvantage of such multi-platform analysis approaches is the need to convert results into common data formats that can be shared between the different software environments. Often this conversion is done either manually or with custom “one-off” reformatting scripts. Errors in this process can lead to extremely serious data distortions. Predictive modeling system 1000 may avoid such reformatting and data transfer errors by performing all computations in one software environment. More generally, because it is highly automated, fitting and optimizing many different model structures, the predictive modeling system 1000 can provide a substantially faster and more systematic, thus more readily explainable and more repeatable, route to the final model. Moreover, as a consequence of the predictive modeling system 1000 exploring more different modeling methods and including more possible predictors, the resulting models may be more accurate than those obtained by traditional methods.

Predicting Properties

In many fields, organizations face uncertainty in the outcome of a production process and want to predict how a given set of conditions will affect the final properties of the output. Therefore, a common application of machine learning is to develop algorithms that predict these properties. For example, concrete is a common building material whose final structural properties can vary dramatically from one situation to another. Due to the significant variations in concrete properties with time and their dependence on its highly variable composition, neither models developed from first principles nor traditional regression models offer adequate predictive accuracy.

In some implementations, the techniques described herein can be used for predicting properties of the outcome of a production process (e.g., properties of concrete). For example, the techniques described herein may be applied to the problem of predicting properties of concrete as follows. This technical solution is not limited to the order of operations as discussed herein.

1. Partition the dataset into training, validation, and test subsets.

2. Clean the modeling dataset: The predictive modeling system 1000 may automatically check for missing data, outliers, and other data anomalies, recommending treatment strategies and offering the user the option to accept or decline them. This approach may require less skill and effort by the user, and/or may provide more consistent results across methods, datasets, and time.

3. Select the response variable and choose a primary fitting metric: The user may select the response variable to be predicted from those available in the modeling dataset. Once the response variable has been chosen, the predictive modeling system 1000 may recommend a compatible fitting metric, which the user may accept or override. This approach may require less skill and effort by the user. Based on the response variable type and the fitting metric selected, the predictive modeling system may offer a set of predictive models, including traditional regression models, neural networks, and other machine learning models (e.g., random forests, boosted trees, support vector machines). By automatically searching among the space of possible modeling approaches, the predictive modeling system 1000 may increase the expected accuracy of the final model. The default set of model choices may be overridden to exclude certain model types from consideration, to add other model types supported by the predictive modeling system but not part of the default list, or to add the user's own custom model types (e.g., implemented in R or Python).

4. Generate input features, fit models, optimize model-specific tuning parameters, and evaluate performance: In some implementations, feature generating may include scaling for numerical covariates, Box-Cox transformations, principal components, etc. Tuning parameters for the models may be optimized via cross-validation. Validation set performance measures may be computed and presented for each model, along with other summary characteristics (e.g., model parameters for regression models, variable importance measures for boosted trees or random forests).

5. Select the final model: The choice of the final model can be made by the predictive modeling system 1000 or by the user. In the latter case, the predictive modeling system may provide support to help the user make this decision, including, for example, the ranked validation set performance assessments for the models, the option of comparing and ranking performance by other quality measures than the one used in the fitting process, and/or the opportunity to build ensemble models from those component models that exhibit the best individual performance.

Inferring Measurements

Some measurements are much more costly to make than others, so organizations may want to substitute cheaper metrics for more expensive ones. Therefore, a common application of machine learning is to infer the likely output of an expensive measurement from the known output of cheaper ones. For example, “curl” is a property that captures how paper products tend to depart from a flat shape, but it can typically be judged only after products are completed. Being able to infer the curl of paper from mechanical properties easily measured during manufacturing can thus result in an enormous cost savings in achieving a given level of quality. For typical end-use properties, the relationship between these properties and manufacturing process conditions is not well understood.

In some implementations, the techniques described herein can be used for inferring measurements. For example, the techniques described herein may be applied to the problem of inferring measurements as follows. This technical solution is not limited to the order of operations as discussed herein.

1. Characterize the modeling datasets: The predictive modeling system 1000 may provide key summary characteristics and offer recommendations for treatment of data anomalies, which the user is free to accept, decline, or request more information about. For example, key characteristics of variables may be computed and displayed, the prevalence of missing data may be displayed and a treatment strategy may be recommended, outliers in numerical variables may be detected and, if found, a treatment strategy may be recommended, and/or other data anomalies may be detected automatically (e.g., inliers, non-informative variables whose values never change) and recommended treatments may be made available to the user.

2. Partition the dataset into training/validation/holdout subsets.

3. Feature generation/model structure selection/model fitting: The predictive modeling system 1000 may combine and automate these steps, allowing extensive internal iteration. Multiple features may be automatically generated and evaluated, using both classical techniques like principal components and newer methods like boosted trees. Many different model types may be fitted and compared, including regression models, neural networks, support vector machines, random forests, boosted trees, and others. In addition, the user may have the option of including other model structures that are not part of this default collection. Model sub-structure selection (e.g., selection of the number of hidden units in neural networks, the specification of other model-specific tuning parameters, etc.) may be automatically performed by extensive cross-validation as part of this model fitting and evaluation process.

4. Select the final model: The choice of the final model can be made by the predictive modeling system 1000 or by the user. In the latter case, the predictive modeling system may provide support to help the user make this decision, including, for example, the ranked validation set performance assessments for the models, the option of comparing and ranking performance by other quality measures than the one used in the fitting process, and/or the opportunity to build ensemble models from those component models that exhibit the best individual performance.

In some implementations, because the predictive modeling system 1000 automates and efficiently implements data pretreatment (e.g., anomaly detection), data partitioning, multiple feature generation, model fitting and model evaluation, the time required to develop models may be much shorter than it is in the traditional development cycle. Further, in some implementations, because the predictive modeling system automatically includes data pretreatment procedures to handle both well-known data anomalies like missing data and outliers, and less widely appreciated anomalies like inliers (repeated observations that are consistent with the data distribution, but erroneous) and postdictors (i.e., extremely predictive covariates that arise from information leakage), the resulting models may be more accurate and more useful. In some implementations, the predictive modeling system 1000 is able to explore a vastly wider range of model types, and many more specific models of each type, than is traditionally feasible. This model variety may greatly reduce the likelihood of unsatisfactory results, even when applied to a dataset of compromised quality.

Referring to FIG. 14, in some implementations, a predictive modeling system 1400 (e.g., an implementation of predictive modeling system 1000) includes at least one client computer 1410, at least one server 1450, and one or more processing nodes 1470. The illustrative configuration is only for exemplary purposes, and it is intended that there can be any number of clients 1410 and/or servers 1450.

In some implementations, predictive modeling system 1400 may perform one or more (e.g., all) steps of method 1200. In some implementations, client 1410 may implement user interface 1020, and the predictive modeling module 1452 of server 1450 may implement other components of predictive modeling system 1000 (e.g., modeling space exploration engine 1010, library of modeling techniques 1030, a library of prediction problems, and/or modeling deployment engine 1040). In some implementations, the computational resources allocated by exploration engine 1010 for the exploration of the modeling search space may be resources of the one or more processing nodes 1470, and the one or more processing nodes 1470 may execute the modeling techniques according to the resource allocation schedule. However, implementations are not limited by the manner in which the components of predictive modeling system 1000 or predictive modeling method 1200 are distributed between client 1410, server 1450, and one or more processing nodes 1470. Furthermore, in some implementations, all components of predictive modeling system 1000 may be implemented on a single computer (instead of being distributed between client 1410, server 1450, and processing node(s) 1470), or implemented on two computers (e.g., client 1410 and server 1450).

One or more communications networks 1430 connect the client 1410 with the server 1450, and one or more communications networks 1480 connect the serer 1450 with the processing node(s) 1470. The networks 1430 or 1480 can include one or more component or functionality of network 970. The communication may take place via any media such as standard telephone lines, LAN or WAN links (e.g., T1, T3, 56 kb, X.25), broadband connections (ISDN, Frame Relay, ATM), and/or wireless links (IEEE 802.11, Bluetooth). The networks 1430/1480 can carry TCP/IP protocol communications, and data (e.g., HTTP/HTTPS requests, etc.) transmitted by client 1410, server 1450, and processing node(s) 1470 can be communicated over such TCP/IP networks. The type of network is not a limitation, however, and any suitable network may be used. Non-limiting examples of networks that can serve as or be part of the communications networks 1430/1480 include a wireless or wired Ethernet-based intranet, a local or wide-area network (LAN or WAN), and/or the global communications network known as the Internet, which may accommodate many different communications media and protocols.

The client 1410 can be implemented with software 1412 running on hardware. In some implementations, the hardware may include a personal capable of running operating systems and/or various varieties of Unix and GNU/Linux. The client 1410 may also be implemented on such hardware as a smart or dumb terminal, network computer, wireless device, wireless telephone, information appliance, workstation, minicomputer, mainframe computer, personal data assistant, tablet, smart phone, or other computing device that is operated as a general purpose computer, or a special purpose hardware device used solely for serving as a client 1410.

Generally, in some implementations, clients 1410 can be operated and used for various activities including sending and receiving electronic mail and/or instant messages, requesting and viewing content available over the World Wide Web, participating in chat rooms, or performing other tasks commonly done using a computer, handheld device, or cellular telephone. Clients 1410 can also be operated by users on behalf of others, such as employers, who provide the clients 1410 to the users as part of their employment.

In various implementations, the software 1412 of client computer 1410 includes client software 1314 and/or a web browser 1416. The web browser 1314 allows the client 1410 to request a web page or other downloadable program, applet, or document (e.g., from the server 1450) with a web-page request. One example of a web page is a data file that includes computer executable or interpretable information, graphics, sound, text, and/or video, that can be displayed, executed, played, processed, streamed, and/or stored and that can contain links, or pointers, to other web pages.

In some implementations, the software 1412 includes client software 1314. The client software 1314 provides, for example, functionality to the client 1410 that allows a user to send and receive electronic mail, instant messages, telephone calls, video messages, streaming audio or video, or other content. Not shown are standard components associated with client computers, including a central processing unit, volatile and non-volatile storage, input/output devices, and a display.

In some implementations, web browser software 1416 and/or client software 1314 may allow the client to access a user interface 1020 for a predictive modeling system 1000.

The server 1450 interacts with the client 1410. The server 1450 can be implemented on one or more server-class computers that have sufficient memory, data storage, and processing power and that run a server-class operating system. System hardware and software other than that specifically described herein may also be used, depending on the capacity of the device and the size of the user base. For example, the server 1450 may be or may be part of a logical group of one or more servers such as a server farm or server network. As another example, there may be multiple servers 1450 associated with or connected to each other, or multiple servers may operate independently, but with shared data. In a further implementation and as is typical in large-scale systems, application software can be implemented in components, with different components running on different server computers, on the same server, or some combination.

In some implementations, server 1450 includes a predictive modeling module 1452, a communications module 1456, and/or a data storage module 1454. In some implementations, the predictive modeling module 1452 may implement modeling space exploration engine 1010, library of modeling techniques 1030, a library of prediction problems, and/or modeling deployment engine 1040. In some implementations, server 1450 may use communications module 1456 to communicate the outputs of the predictive modeling module 1452 to the client 1410, and/or to oversee execution of modeling techniques on processing node(s) 1470. The modules described throughout the specification can be implemented in whole or in part as a software program using any suitable programming language or languages (C++, C#, java, LISP, BASIC, PERL, etc.) and/or as a hardware device (e.g., ASIC, FPGA, processor, memory, storage and the like).

A data storage module 1454 may store, for example, predictive modeling library 1030 and/or a library of prediction problems.

FIG. 15 illustrates an implementation of a predictive modeling system 1000. The discussion of FIG. 15 is given by way of example of some implementations, and is in no way limiting.

To execute the previously described procedures, predictive modeling system 1000 may use a distributed software architecture 1500 running on a variety of client and server computers. The goal of the software architecture 1500 is to simultaneously deliver a rich user experience and computationally intensive processing. The software architecture 1500 may implement a variation of the basic 4-tier Internet architecture. As illustrated in FIG. 15, it extends this foundation to leverage cloud-based computation, coordinated via the application and data tiers.

(1) Clients 1510. The architecture 1500 makes essentially the same assumptions about clients 1510 as any other Internet application. The primary use-case includes frequent access for long periods of time to perform complex tasks. So target platforms include rich Web clients running on a laptop or desktop. However, users may access the architecture via mobile devices. Therefore, the architecture is designed to accommodate native clients 1512 directly accessing the Interface Services APIs using relatively thin client-side libraries. Of course, any cross-platform GUI layers such as Java and Flash, could similarly access these APIs.

(2) Interface Services 1520. This layer of the architecture is an extended version of the basic Internet presentation layer. Due to the sophisticated user interaction that may be used to direct machine learning, alternative implementations may support a wide variety of content via this layer, including static HTML, dynamic HTML, SVG visualizations, executable Javascript code, and even self-contained IDEs. Moreover, as new Internet technologies evolve, implementations may need to accommodate new forms of content or alter the division of labor between client, presentation, and application layers for executing user interaction logic. Therefore, their Interface Services layers 1520 may provide a flexible framework for integrating multiple content delivery mechanisms of varying richness, plus common supporting facilities such as authentication, access control, and input validation.

(3) Analytic Services 1530. The architecture may be used to produce predictive analytics solutions, so its application tier focuses on delivering Analytic Services. The computational intensity of machine learning drives the primary enhancement to the standard application tier the dynamic allocation of machine-learning tasks to large numbers of virtual “workers” running in cloud environments. For every type of logical computation request generated by the execution engine, the Analytic Services layer 1530 coordinates with the other layers to accept requests, break requests into jobs, assign jobs to workers, provide the data necessary for job execution, and collate the execution results. There is also an associated difference from a standard application tier. The predictive modeling system 1000 may allow users to develop their own machine-learning techniques and thus some implementations may provide one or more full IDEs, with their capabilities partitioned across the Client, Interface Services, and Analytic Services layers. The execution engine then incorporates new and improved techniques created via these IDEs into future machine-learning computations.

(4) Worker Clouds 1540. To efficiently perform modeling computations, the predictive modeling system 1000 may break them into smaller jobs and allocates them to virtual worker instances running in cloud environments. The architecture 1500 allows for different types of workers and different types of clouds. Each worker type corresponds to a specific virtual machine configuration. For example, the default worker type provides general machine-learning capabilities for trusted modeling code. But another type enforces additional security “sandboxing” for user-developed code. Alternative types might offer configurations optimized for specific machine-learning techniques. As long as the Analytic Services layer 1530 understands the purpose of each worker type, it can allocate jobs appropriately. Similarly, the Analytic Services layer 1530 can manage workers in different types of clouds. An organization might maintain a pool of instances in its private cloud as well as have the option to run instances in a public cloud. It might even have different pools of instances running on different kinds of commercial cloud services or even a proprietary internal one. As long as the Analytic Services layer 1530 understands the tradeoffs in capabilities and costs, it can allocate jobs appropriately.

(5) Data Services 1550. The architecture 1500 assumes that the various services running in the various layers may benefit from a corresponding variety of storage options. Therefore, it provides a framework for delivering a rich array of Data Services 1550, e.g., file storage for any type of permanent data, temporary databases for purposes such as caching, and permanent databases for long-term record management. Such services may even be specialized for particular types of content such as the virtual machine image files used for cloud workers and IDE servers. In some cases, implementations of the Data Services layer 1550 may enforce particular access idioms on specific types of data so that the other layers can smoothly coordinate. For instance, standardizing the format for datasets and model results means the Analytic Services layer 1530 may simply pass a reference to a user's dataset when it assigns a job to a worker. Then, the worker can access this dataset from the Data Services layer 1550 and return references to the model results which it has, in turn, stored via Data Services 1550.

(6) External Systems 1560. Like any other Internet application, the use of APIs may enable external systems to integrate with the predictive modeling system 1000 at any layer of the architecture 1500. For example, a business dashboard application could access graphic visualizations and modeling results through the Interface Services layer 1520. An external data warehouse or even live business application could provide modeling datasets to the Analytic Services layer 1530 through a data integration platform. A reporting application could access all the modeling results from a particular time period through the Data Services layer 1550. However, under most circumstances, external systems would not have direct access to Worker Clouds 1540; they would utilize them via the Analytic Services layer 1530.

As with all multi-tiered architectures, the layers of architecture 1500 are logical. Physically, services from different layers could run on the same machine, different modules in the same layer could run on separate machines, and multiple instances of the same module could run across several machines. Similarly, the services in one layer could run across multiple network segments and services from different layers may or may not run on different network segments. But the logical structure helps coordinate developers' and operators' expectations of how different modules will interact, as well as gives operators the flexibility necessary to balance service-level requirements such as scalability, reliability, and security.

While the high-level layers appear reasonably similar to those of a typical Internet application, the addition of cloud-based computation may substantially alter how information flows through the system.

Internet applications usually offer two distinct types of user interaction: synchronous and asynchronous. With conceptually synchronous operations, such as finding an airline flight and booking a reservation, the user makes a request and waits for the response before making the next request. With conceptually asynchronous operations, such as setting an alert for online deals that meet certain criteria, the user makes a request and expects the system to notify him at some later time with results. (Typically, the system provides the user an initial request “ticket” and offers notification through a designated communications channel.)

In contrast, building and refining machine-learning models may involve an interaction pattern somewhere in the middle. Setting up a modeling problem may involve an initial series of conceptually synchronous steps. But when the user instructs the system to begin computing alternative solutions, a user who understands the scale of the corresponding computations is unlikely to expect an immediate response. Superficially, this expectation of delayed results makes this phase of interaction appear asynchronous.

However, predictive modeling system 1000 doesn't force the user to “fire-and-forget”, i.e., stop his own engagement with the problem until receiving a notification. In fact, it may encourage him to continue exploring the dataset and review preliminary results as soon as they arrive. Such additional exploration or initial insight might inspire him to change the model-building parameters “in-flight”. The system may then process the requested changes and reallocate processing tasks. The predictive modeling system 1000 may allow this request-and-revise dynamic continuously throughout the user's session.

The predictive modeling system 1000 may not fit cleanly into the layered model, which assumes that each layer mostly only relies on the layer directly below it. Various analytic services and data services can cooperatively coordinate users and computation.

To make operational predictions, a user may want an independent prediction service, completely separate from the model building computing infrastructure. An independent prediction service may run in a different computing environment or be managed as a distinct component within a shared computing environment. Once instantiated, the service's execution, security, and monitoring may be fully separated from the model building environment allowing the user to deploy and manage it independently.

After instantiating the service, the deployment engine may allow the user to install fitted models into the service. To enhance (e.g., optimize) performance, the implementation of a modeling technique suitable for fitting models may be suboptimal for making predictions. For example, fitting a model requires running the same algorithm repeatedly so it is often worthwhile to invest a significant amount of overhead into enabling fast parallel execution of the algorithm. However, if the expected rate of prediction requests isn't very high, that same overhead may not be worthwhile for an independent prediction service. In some cases, a modeling technique developer may even provide specialized versions of one or more of its component execution tasks that provide better performance characteristics in a prediction environment. In particular, implementations designed for highly parallel execution or execution on specialized processors may be advantageous for prediction performance. Similarly, in cases where a modeling technique includes tasks specified in a programming language, pre-compiling the tasks at the time of service instantiation rather than waiting until service startup or an initial request for a prediction from that model may provide a performance improvement.

Also, model fitting tasks generally use computing infrastructure differently than a prediction service. To protect a cloud infrastructure from errors during modeling technique execution and to prevent access to modeling techniques from other users in the cloud, modeling techniques may execute in secure computing containers during model fitting. However, prediction services often run on dedicated machines or clusters. Removing the secure container layer may therefore reduce overhead without any practical disadvantage.

Therefore, based on the specific tasks executed by a model's modeling technique, the expected load, and the characteristics of the target computing environment for prediction, the deployment engine may use a set of rules for packaging and deploying the model. These rules may optimize execution.

Because a given prediction service may execute multiple models, the service may allocate computing resources across prediction requests for each model. There are two basic cases, deployments to one or more server machines and deployments to computing clusters.

In the case of deployments to servers, the challenge is how to allocate requests among multiple servers. The prediction service may have several types of a priori information. Such information may include (a) estimates of how long it takes to execute a prediction for each configured model, (b) the expected frequency of requests for each configured model at different times, and (c) the desired priority of model execution. Estimates of execution time may be calculated based on measuring the actual execution speed of the prediction code for each model under one or more conditions. The desired priority of model execution may be specified by a service administrator. The expected frequency of requests could be computed from historical data for that model, forecast based on a meta-machine learning model, or provided by an administrator.

The service may include an objective function that combines some or all of these factors to compute a fraction of all available servers' aggregate computing power that may be initially allocated to each model. As the service receives and executes requests, it naturally obtains updated information on estimates of execution time and expected frequency of requests. Therefore, the service may recalculate these fractions and reallocate models to servers accordingly.

A deployed prediction service may have two different types of server processes: routers and workers. One or more routers may form a routing service that accepts requests for predictions and allocates them to workers. Incoming requests may have a model identifier indicating which prediction model to use, a user or client identifier indicating which user or software system is making the request, and one or more vectors of predictor variables for that model.

When a request comes into a dedicated prediction service, its routing service may inspect some combination of the model identifier, user or client identifier, and number of vectors of predictor variables. The routing service may then allocate requests to workers to increase (e.g., maximize) server cache hits for instructions and data used (1) in executing a given model and/or (2) for a given user or client. The routing service may also take into account the number of vectors of predictor variables to achieve a mixture of batch sizes submitted to each worker that balances latency and throughput.

Examples of algorithms for allocating requests for a model across workers may include round-robin, weighted round robin based on model computation intensity and/or computing power of the worker, and dynamic allocation based on reported load. To facilitate quick routing of requests to the designated server, the routing service may use a hash function that chooses the same server given the same set of observed characteristics (e.g., model identifier). The hash function may be a simple hash function or a consistent hash function. A consistent hash function requires less overhead when the number of nodes (corresponding to workers in this case) changes. So if a worker goes down or new workers are added, a consistent hash function can reduce the number of hash keys that must be recomputed.

In addition to enhancing (e.g., optimizing) performance by intelligently distributing prediction requests among available services, a prediction service may enhance (e.g., optimize) the performance of individual models by intelligently configuring how each worker executes each model. For example, if a given server receives a mix of requests for several different models, loading and unloading models for each request may incur substantial overhead. However, aggregating requests for batch processing may incur substantial latency. In some implementations, the service can intelligently make this tradeoff if the administrator specifies the latency tolerance for a model. For example, urgent requests may have a latency tolerance of only 100 milliseconds in which case a server may process only one or at most a few requests. In contrast, a latency tolerance might of two seconds may enable batch sizes in the hundreds. Due to overhead, increasing the latency tolerance by a factor of two may increase throughput by 10× to 100×.

Similarly, using operating system threads may improve throughput while increasing latency, due to the thread set up and initialization overhead. In some cases, predictions may be extremely latency sensitive. If all the requests to a given model are likely to be latency sensitive, then the service may configure the servers handling those requests to operate in single threaded mode. Also, if only a subset of requests are likely to be latency sensitive, the service may allow requesters to flag a given request as sensitive. In this case, the server may operate in single threaded mode only while servicing the specific request.

In some cases, a user's organization may have batches of predictions that the organization wants to use a distributed computing cluster to calculate as rapidly as possible. Distributed computing frameworks generally allow an organization to set up a cluster running the framework, and any programs designed to work with the framework can then submit jobs comprising data and executable instructions.

Because the execution of one prediction on a model does not affect the result of another prediction on that model, or the result of any other model, predictions are stateless operations in the context of a cluster computing and thus are generally very easy to make parallel. Therefore, given a batch of data and executable instructions, the normal behavior of the framework's partitioning and allocation algorithms may result in linear scaling.

In some cases, making predictions may be part of a large workflow in which data is produced and consumed in many steps. In such cases, prediction jobs may be integrated with other operations through publish-subscribe mechanisms. The prediction service subscribes to channels that produce new observations that require predictions. After the service makes predictions, it publishes them to one or more channels that other programs may consume.

Fitting modeling techniques and/or searching among a large number of alternative techniques can be computationally intensive. Computing resources may be costly. Some implementations of the system 1000 for producing predictive models identifies opportunities to reduce resource consumption.

Based on user preferences, the engine 1010 may adjust its search for models to reduce execution time and consumption of computing resources. In some cases, a prediction problem may include a lot of training data. In such cases, the benefit of cross validation is usually lower in terms of reducing model bias. Therefore, the user may prefer to fit a model on all the training data at once rather than on each cross validation fold, because the computation time of one run on five to ten times the amount of data is typically much less than five to 10 runs on one-fifth to one-tenth the amount of data.

Even in cases where a user does not have a relatively large training set, the user may still wish to conserve time and resources. In such cases, the engine 1010 may offer a “greedier” option that uses several more aggressive search approaches. First, the engine 1010 can try a smaller subset of possible modeling techniques (e.g., only those whose expected performance is relatively high). Second, the engine 1010 may prune underperforming models more aggressively in each round of training and evaluation. Third, the engine 1010 may take larger steps when searching for the optimal hyper-parameters for each model.

In general, searching for the better (e.g., optimal) hyper-parameters can be costly. So even if the user wants to the engine 1010 to evaluate a wide spectrum of potential models and not prune them aggressively, the engine can still conserve resources by limiting (e.g., optimizing) the hyper-parameter search. The cost of this search is generally proportional to the size of the dataset. One strategy is to tune the hyper-parameters on a small fraction of the dataset and then extrapolate these parameters to the entire dataset. In some cases, adjustments are made to account for the larger amount of data. In some implementations, the engine 1010 can use one of two strategies. First, the engine 1010 can perform the adjustment based on heuristics for that modeling technique. Second, the engine 1010 can engage in meta-machine learning, tracking how each modeling technique's hyper-parameters vary with dataset size and building a meta predictive model of those hyper-parameters, then applying that meta model in cases where the user wants to make the tradeoff.

When working with a categorical prediction problem, there may be a minority class and a majority class. The minority class may be much smaller but relatively more useful, as in the case of fraud detection. In some implementations, the engine 1010 “down-samples” the majority class so that the number of training observations for that class is more similar to that for the minority class. In some cases, modeling techniques may automatically accommodate such weights directly during model fit. If the modeling techniques do not accommodate such weights, the engine 1010 can make a post-fit adjustment proportional to the amount of down-sampling. This approach may sacrifice some accuracy for much shorter execution times and lower resource consumption.

Some modeling techniques may execute more efficiently than others. For example, some modeling techniques may be optimized to run on parallel computing clusters or on servers with specialized processors. Each modeling technique's metadata may indicate any such performance advantages. When the engine 1010 is assigning computing jobs, it may detect jobs for modeling techniques whose advantages apply in the currently available computing environment. Then, during each round of search, the engine 1010 may use bigger chunks of the dataset for those jobs. Those modeling techniques may then complete faster. Moreover, if their accuracy is great enough, there may be no need to even test other modeling techniques that are performing relatively poorly.

User Interface (UI) Enhancements

The engine 1010 may help users produce better predictive models by extracting more information from them before model building, and may provide users with a better understanding of model performance after model fitting.

In some cases, a user may have additional information about datasets that is suitable for better directing the search for accurate predictive models. For example, a user may know that certain observations have special significance and want to indicate that significance. The engine 1010 may allow the user to easily create new variables for this purpose. For example, one synthetic variable may indicate that the engine should use particular observations as part of the training, validation, or holdout data partitions instead of assigning them to such partitions randomly. This capability may be useful in situations where certain values occur infrequently and corresponding observations should be carefully allocated to different partitions. This capability may be useful in situations where the user has trained a model using a different machine learning system and wants to perform a comparison where the training, validation, and holdout partitions are the same.

Similarly, certain observations may represent particularly useful or indicative events to which the user wants to assign additional weight. Thus, an additional variable inserted into the dataset may indicate the relative weight of each observation. The engine 1010 may then use this weight when training models and calculating their accuracy, with the goal being to produce more accurate predictions under higher-weighted conditions.

In other cases, the user may have prior information about how certain features should behave in the models. For example, a user may know that a certain feature should have a monotonic effect on the prediction target over a certain range. In automobile insurance, it is generally believed that the chance of accident increases monotonically with age after the age of 30. Another example is creating bands for otherwise continuous variables. Personal income is continuous, but there are analytic conventions for assigning values to bands such as $10K increments up until $100K and then $25K bands until $250K, and any income greater than $250K. Then there are cases where limitations on the dataset require constraints on specific features. Sometimes, categorical variables may have a very large number of values relative to the size of dataset. The user may wish to indicate either that the engine 1010 should ignore categorical features that have more than a certain number of possible categories or limit the number of categories to the most frequent X, assigning all other values to an “Other” category. In all these situations, the user interface may present the user with the option of specifying this information for each feature detected (e.g., at step 1312 of the method 1300).

The user interface may provide guided assistance in transforming features. For example, a user may want to convert a continuous variable into a categorical variable, but there may be no standard conventions for that variable. By analyzing the shape of the distribution, the engine 1010 may choose the optimal number of categorical bands and the points at which to place “knots” in the distribution that define the boundaries between each band. Optionally, the user may override these defaults in the user interface by adding or deleting knots, as well as moving the location of the knots.

Similarly, for features that are already categorical, the engine 1010 may simplify their representation by combining one or more categories into a single category. Based on the relative frequency of each observed category and the frequency with which they appear relative to the values of other features, the engine 1010 may calculate the optimal way to combine categories. Optionally, the user may override these calculations by removing original categories from a combined category and/or putting existing categories into a combined category.

In certain cases, a prediction problem may include events that occur at irregular intervals. In such cases, it may be useful to automatically create a new feature that captures how many of these events have occurred within a particular time frame. For example, in insurance prediction problems, a dataset may have records of each time a policy holder had a claim. However, in building a model to predict future risk, it may be more useful to consider how many claims a policy-holder has had in the past X years. The engine may detect such situations when it evaluates the dataset (e.g., step 508 of the method 500) by detecting data structure relationships between records corresponding to entities and other records corresponding to events. When presenting the dataset to the user (e.g., at step 510), the user interface may automatically create or suggest creating such a feature. It may also suggest a time frame threshold based on the frequency with which the event occurs, calculated to maximize the statistical dependency between this variable and the occurrence of future events, or using some other heuristic. The user interface may also allow the user to override the creation of such a feature, force the creation of such a feature, and override the suggested time frame threshold.

When the system makes predictions based on models, users may wish to review these predictions and explore unusual ones. For example, the user interface may provide a list of all or a subset of predictions for a model and indicate which ones were extreme, either in terms of the magnitude of the value of the predictor or its low probability of having that value. Moreover, it is also possible to provide insight into the reason for the extreme value. For example, in an automobile insurance risk model, a particular high value may have the reason “age <25 and marital status=single.”

Although examples provided herein may have described modules as residing on separate computers or operations as being performed by separate computers, it should be appreciated that the functionality of these components can be implemented on a single computer, or on any larger number of computers in a distributed fashion.

The above-described implementations may be implemented in any of numerous ways. For example, the implementations may be implemented using hardware, software or a combination thereof. When implemented in software, the software code can be executed on any suitable processor or collection of processors, whether provided in a single computer or distributed among multiple computers. Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, some implementations may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various implementations discussed above. The computer readable medium or media may be non-transitory. The computer readable medium or media can be transportable, such that the program or programs stored thereon can be loaded onto one or more different computers or other processors to implement various aspects of predictive modeling as discussed above. The terms “program” or “software” are used herein in a generic sense to refer to any type of computer code or set of computer-executable instructions that can be employed to program a computer or other processor to implement various aspects described in the present disclosure. Additionally, it should be appreciated that according to one aspect of this disclosure, one or more computer programs that when executed perform predictive modeling methods need not reside on a single computer or processor, but may be distributed in a modular fashion amongst a number of different computers or processors to implement various aspects of predictive modeling.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various implementations.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish a relationship between data elements.

Also, predictive modeling techniques may be embodied as a method, of which an example has been provided. The acts performed as part of the method may be ordered in any suitable way. Accordingly, implementations may be constructed in which acts are performed in an order different than illustrated, which may include performing some acts simultaneously, even though shown as sequential acts in illustrative implementations.

In some implementations the method(s) may be implemented as computer instructions stored in portions of a computer's random access memory to provide control logic that affects the processes described above. In such an implementation, the program may be written in any one of a number of high-level languages, such as FORTRAN, PASCAL, C, C++, C#, Java, JavaScript, Tcl, or BASIC. Further, the program can be written in a script, macro, or functionality embedded in commercially available software. Additionally, the software may be implemented in an assembly language directed to a microprocessor resident on a computer. The software may be embedded on an article of manufacture including, but not limited to, “computer-readable program means” such as a floppy disk, a hard disk, an optical disk, a magnetic tape, a PROM, an EPROM, or CD-ROM.

Various aspects of the present disclosure may be used alone, in combination, or in a variety of arrangements not specifically described in the foregoing, and the solution is therefore not limited in its application to the details and arrangement of components set forth in the foregoing description or illustrated in the drawings. For example, aspects described in one implementation may be combined in any manner with aspects described in other implementations.

The phraseology and terminology used herein is for the purpose of description and should not be regarded as limiting.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one implementation of this solution, it is to be appreciated that various alterations, modifications, and improvements will readily occur to those skilled in the art. Such alterations, modifications, and improvements are intended to be part of this disclosure, and are intended to be within the spirit and scope of the solution. Accordingly, the foregoing description and drawings are by way of example only.

What is claimed is:

1. A system comprising:
one or more processors, coupled to memory, to:
segment a time series range into a first segment for an instance of time, the first segment associated with a first value for a target feature and a first timestamp for the first value;
segment the time series range into an input segment associated with a plurality of input features and a segment timestamp less than or equal to the first timestamp;
generate a model trained with input comprising values for the target feature and timestamps less than or equal to the segment timestamp; and
transform at least one of the input features based at least on the model.

2. The system of claim 1, wherein the one or more processors are further configured to:
generate a plurality of impact metrics associated with corresponding ones of the input features, the impact metrics being based on the model, the first value, and input values.

3. The system of claim 2, wherein the one or more processors are further configured to:
transform at least one of the input features based on at least one of the impact metrics.

4. The system of claim 3, wherein the one or more processors are further configured to:
generate at least one user interface presentation including one or more of the transformed input features, in response to a determination that corresponding impact features associated with the one or more of the transformed input features satisfy an impact threshold.

5. The system of claim 1, wherein the one or more processors are further configured to:
generate the model with input including the input features and the target feature.

6. The system of claim 1, wherein at least one of the input timestamps is less than the first timestamp.

7. The system of claim 1, wherein the first timestamp corresponds to a current time, and the segment timestamp corresponds to a past time.

8. The system of claim 1, wherein the model is trained with input including the input features and the first value.

9. The system of claim 1, wherein each of the impact metrics are associated with respective ones of the input features.

10. The system of claim 1, wherein the one or more processors are further configured to:
generate at least one user interface presentation including at least one calendar object associated with the time series structure.

11. A method comprising:
segmenting, by a data processing system, a time series range into a first segment for an instance of time, the first segment associated with a first value for a target feature and a first timestamp for the first value;
segmenting, by the data processing system, the time series range into an input segment associated with a plurality of input features and a segment timestamp less than or equal to the first timestamp; and
generating, by the data processing system, a model trained with input comprising values for the target feature and timestamps less than or equal to the segment timestamp; and
transforming, by the data processing system, at least one of the input features based at least on the model.

12. The method of claim 11, further comprising:
generating, by the data processing system, a plurality of impact metrics associated with corresponding ones of the input features, the impact metrics being based on the model, the first value, and input values.

13. The method of claim 12, further comprising:
transforming, by the data processing system, at least one of the input features based on at least one of the impact metrics.

14. The method of claim 13, further comprising:
generating, by the data processing system, at least one user interface presentation including one or more of the transformed input features, in response to a determination that corresponding impact features associated with the one or more of the transformed input features satisfy an impact threshold.

15. The method of claim 11, further comprising:
generating, by the data processing system, the model with input including the input features and the target feature.

16. The method of claim 11, wherein at least one of the input timestamps is less than the first timestamp.

17. The method of claim 11, wherein the first timestamp corresponds to a current time, and the segment timestamp corresponds to a past time.

18. The method of claim 11, wherein the model is trained with input including the input features and the first value.

19. The method of claim 11, wherein each of the impact metrics are associated with respective ones of the input features.

20. A computer readable medium including one or more instructions stored thereon and executable by a processor to:
segment a time series range into a first segment for an instance of time, the first segment associated with a first value for a target feature and a first timestamp for the first value;
segment the time series range into an input segment associated with a plurality of input features and a segment timestamp less than or equal to the first timestamp;
generate a model trained with input comprising values for the target feature, and timestamps less than or equal to the segment timestamp; and
transform at least one of the input features based at least on the model.
